(19) United States
(12) Patent Application Publication
(10) Pub. No.: US 2025/0324455 A1
(43) Pub. Date: Oct. 16, 2025

(54) PERIOD FOR MULTI-ACCESS POINT COMMUNICATION

(71) Applicant: Ofinno, LLC, Reston, VA (US)

(72) Inventors: Jiayi Zhang, Rockville, MD (US); Jeongki Kim, Fairfax, VA (US); Esmael Hejazi Dinan, McLean, VA (US); Leonardo Alisasis Lanante, Reston, VA (US)

(73) Assignee: Ofinno, LLC, Reston, VA (US)

(21) Appl. No.: 19/250,559

(22) Filed: Jun. 26, 2025

Related U.S. Application Data
(63) Continuation of application No. PCT/US2023/086229, filed on Dec. 28, 2023.
(60) Provisional application No. 63/435,757, filed on Dec. 28, 2022.
(60) Provisional application No. 63/435,759, filed on Dec. 28, 2022.

(51) Int. Cl. H04W 74/0816; H04W 74/00; H04W 74/04

(52) U.S. Cl. CPC H04W 74/0816; H04W 74/002; H04W 74/04

(57) ABSTRACT

In an aspect, a first access point (AP) receives from a second AP, a first frame comprising information indicating a period of unavailability for the second AP to participate in a multi-AP transmission. Based on the first frame, the first AP transmits to the second AP a second frame to initiate the multi-AP transmission before or after the period of unavailability. In another aspect, a first access point (AP) receives from a second AP, a first frame comprising information indicating a period for a multi-AP transmission. The first AP transmits to the second AP, a second frame indicating a decision by the second AP to participate in the multi-AP transmission based on the first frame. The first AP receives from the second AP, a third frame to initiate the multi-AP transmission based on the decision.

### CROSS-REFERENCE TO RELATED APPLICATIONS

This application is a continuation of International Application No. PCT/US2023/086229, filed Dec. 28, 2023, which claims the benefit of U.S. Provisional Application No. 63/435,757, filed Dec. 28, 2022, and U.S. Provisional Application No. 63/435,759, filed Dec. 28, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example Medium Access Control (MAC) frame format.

FIG. 4 illustrates an example control frame used as a trigger frame.

FIG. 5 illustrates an example management frame used as an action frame.

FIG. 6 illustrates an example data frame used as a Quality of Service (QOS) null frame.

FIG. 7 illustrates an example multi-access point (AP) network.

FIG. 8 illustrates an example multi-AP operation procedure.

FIG. 9 illustrates an example of a repeated multi-AP selection phase and multi-AP data transmission phase.

FIG. 10 illustrates an example multi-AP selection phase.

FIG. 11 illustrates an example multi-AP data transmission phase.

FIG. 12 illustrates an example of target wake time (TWT).

FIG. 13 is an example multi-AP operation using operations disclosed herein.

FIG. 14 illustrates an example multi-AP operation using frame exchanges including information indicating a period for a multi-AP transmission.

FIG. 15 illustrates another example multi-AP operation using frame exchanges including information indicating a period for a multi-AP transmission.

FIG. 16 illustrates an example multi-AP operation using frame exchanges including information indicating a plurality of periods for multi-AP transmissions.

FIG. 17 illustrates another example multi-AP operation using frame exchanges including information indicating a period for a multi-AP transmission.

FIG. 18 illustrates an example control frame including a period for a multi-AP transmission.

FIG. 19 illustrates an example action frame including a period for a multi-AP transmission.

FIG. 20 illustrates example multi-AP operation used to carry out a multi-AP transmission according to an aspect of the present disclosure.

FIG. 21 illustrates another example procedure multi-AP operation used to carry out a multi-AP transmission according to an aspect of the present disclosure.

FIG. 22 illustrates another example procedure multi-AP operation used to carry out a multi-AP transmission according to an aspect of the present disclosure.

FIG. 23 illustrates an example process according to an aspect of the present disclosure.

FIG. 24 illustrates an example process according to an aspect of the present disclosure.

FIG. 25 illustrates an example multi-AP operation using frame exchanges including information indicating a period of unavailability for a second AP to participate in a multi-AP transmission.

FIG. 26 illustrates another example multi-AP operation using frame exchanges including information indicating a period of unavailability for a second AP to participate in a multi-AP transmission.

FIG. 27 illustrates another example multi-AP operation using frame exchanges including information indicating a plurality of periods of unavailability for a second AP to participate in a multi-AP transmission.

FIG. 28 illustrates an example data frame including a period of unavailability.

FIG. 29 illustrates an example action frame including a period of unavailability.

FIG. 30 illustrates an example multi-AP operation used to carry out a multi-AP transmission according to an aspect of the present disclosure.

FIG. 31 illustrates another example multi-AP operation used to carry out a multi-AP transmission according to an aspect of the present disclosure.

FIG. 32 illustrates another example multi-AP operation used to carry out a multi-AP transmission according to an aspect of the present disclosure.

FIG. 33 illustrates another example multi-AP operation used to carry out a multi-AP transmission according to an aspect of the present disclosure.

FIG. 34 illustrates an example process according to an aspect of the present disclosure.

FIG. 35 illustrates an example process according to an aspect of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

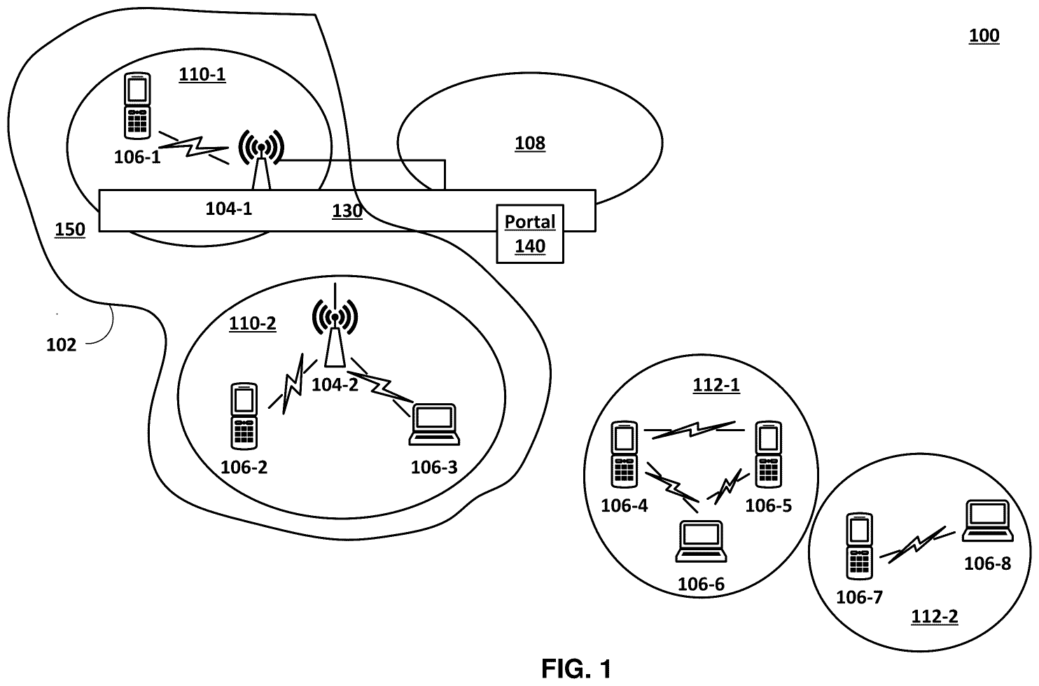

FIG. 1 illustrates example wireless communication networks 100 in which embodiments of the present disclosure may be implemented.

As shown in FIG. 1, the example wireless communication networks 100 may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STA 106-2 and STA 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, AP 104-1 and AP 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STA 106-4, STA 106-5, and 106-6 may be configured to form a first IBSS 112-1. Similarly, STA 106-7 and STA 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHZ, 5 GHZ, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHZ, 80 MHZ, 160 MHZ, or 1120 MHz by bonding together multiple 20 MHz channels.

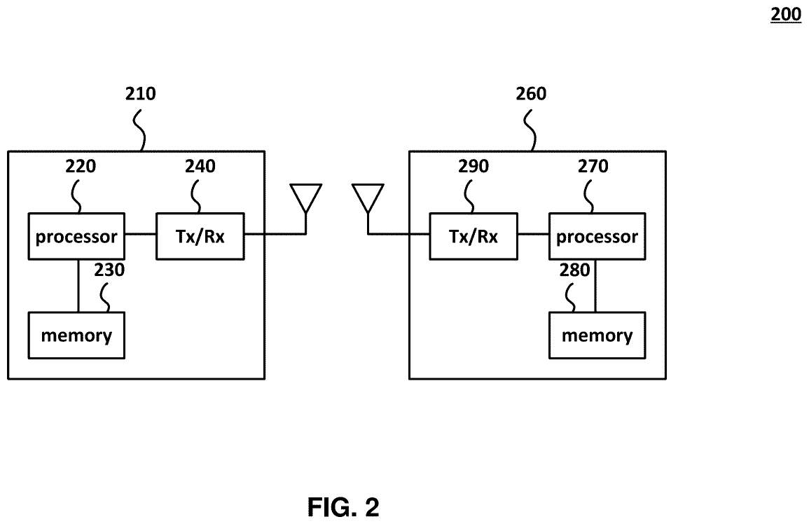

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

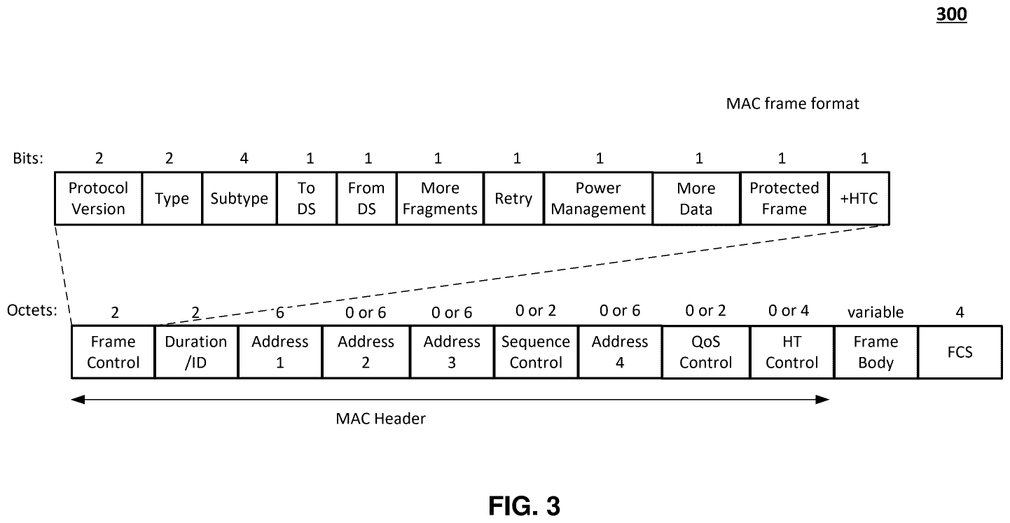

FIG. 3 illustrates an example format of a MAC frame 300. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, MAC frame 300 includes a MAC header, a variable length frame body, and a frame check sequence (FCS).

The MAC header includes a frame control field, an optional duration/ID field (not in PS-Poll frames), address fields, an optional sequence control field, an optional QoS control field (only in QoS Data frames), and an optional high throughput (HT) control field (only in +HTC frames).

The frame control field includes the following subfields: protocol version, type, subtype, To DS, From DS, more fragments, retry, power management, more data, protected frame, and high throughput control (+HTC).

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contains no frame body field.

The To DS subfield indicates whether a data frame is destined to the DS. The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (BUs) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that MAC frame 300 contains an HT control field. A frame that contains the HT Control field is referred to as a +HTC frame. A Control Wrapper frame is a +HTC frame.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that it indicates to a STA an amount of time during which it must defer from accessing the shared medium.

There can be up to four address fields in the format of MAC frame 300. These fields are used to indicate the basic service set identifier (BSSID), source address (SA), destination address (DA), transmitting address (TA), and receiving address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which MAC frame 300 belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field. The control frame subtype for which HT control field is present is the control wrapper frame. A control frame that is described as +HTC (e.g., a request to send (RTS)+HTC, clear to send (CTS)+HTC, block acknowledgment (BlockAck)+HTC or block acknowledgment request (BlockAckReq)+HTC frame) implies the use of the control wrapper frame to carry that control frame.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

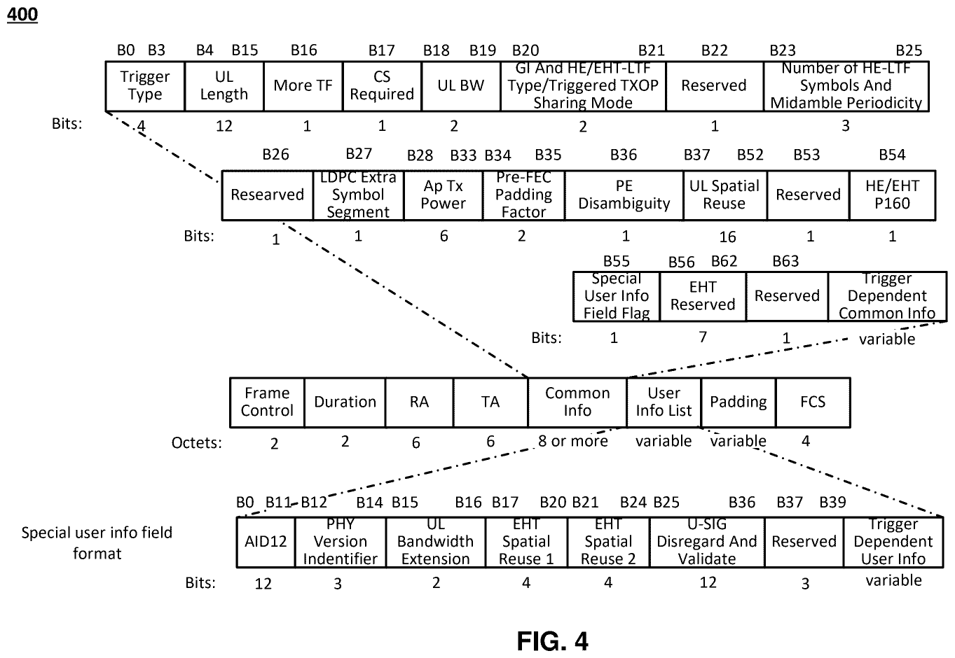

FIG. 4 illustrates an example format of a trigger frame 400. Trigger frame 400 may be used by an AP to allocate resources for and solicit one or more TB PPDU transmissions from one or more STAs. Trigger frame 400 may also carry other information required by a responding STA to transmit a TB PPDU to the AP.

As shown in FIG. 4, trigger frame 400 includes a Frame Control field, a Duration field, a receiver address (RA) field, a transmitter address (TA) field, a Common Info field, a User Info List field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 400 if trigger frame 400 is addressed to STAs that belong to a single BSS. The TA field is the transmitted BSSID if trigger frame 400 is addressed to STAs from at least two different BSSs of the multiple BSSID set.

The Common Info field specifies a trigger frame type of trigger frame 400, a transmit power of trigger frame 400 in dBm, and several key parameters of a TB PPDU that is transmitted by a STA in response to trigger frame 400. The trigger frame type of a trigger frame used by an AP to receive QoS data using UL MU operation is referred to as a basic trigger frame. A non-EHT non-AP HE STA interprets the Common Info field as HE variant. A non-AP EHT STA interprets the Common Info field as HE variant if B54 and B55 in the Common Info field are equal to 1; and interprets the Common Info field as EHT variant otherwise. The HE variant Common Info field and the EHT variant Common Info field use the same encoding method for the Trigger Type, UL Length, More TF, CS Required, LDPC Extra Symbol Segment, AP TX Power, Pre-FEC Padding Factor, PE Disambiguity, and Trigger Dependent Common Info subfields.

The User Info List field contains zero or more User Info fields. There are three variants for the User Info field, which are HE variant User Info field, EHT variant User Info, and Special User Info field.

The Special User Info field is a User Info field that does not carry the user specific information but carries the extended common information not provided in the Common Info field. If the Special User Info field is included in the Trigger frame, then the Special User Info Field Flag subfield of the EHT variant Common Info field is set to 0, otherwise it is set to 1. The Special User Info field is identified by an AID12 value of 2007 and is optionally present in a Trigger frame that is generated by an EHT AP. The Special User Info field, if present, is located immediately after the Common Info field of the Trigger frame and carries information for the U-SIG field of a solicited EHT TB PPDU. The PHY Version Identifier subfield indicates the PHY version of the solicited TB PPDU that is not an HE TB PPDU. The PHY Version Identifier subfield is set to 0 for EHT. Other values from 1 to 7 are reserved. The UL Bandwidth Extension subfield, together with the UL BW subfield in the Common Info field, indicates the bandwidth of the solicited TB PPDU from the addressed EHT STA (i.e., the bandwidth in the U-SIG field of the EHT TB PPDU). The EHT Spatial Reuse n subfield carries the values to be included in the corresponding Spatial Reuse n subfield in the U-SIG field of the EHT TB PPDU. The U-SIG Disregard And Validate subfield carries the values to be included in the Disregard and Validate subfields of the U-SIG field of the solicited EHT TB PPDUs. The presence and length of the Trigger Dependent User Info subfield in the Special User Info field depends on the variant of the Trigger frame.

The Padding field is optionally present in trigger frame 400 to extend the frame length to give recipient STAs enough time to prepare a response for transmission one SIFS after the frame is received. The Padding field, if present, is at least two octets in length and is set to all 1s.

The FCS field is used by a STA to validate a received frame and to interpret certain fields from the MAC headers of a frame.

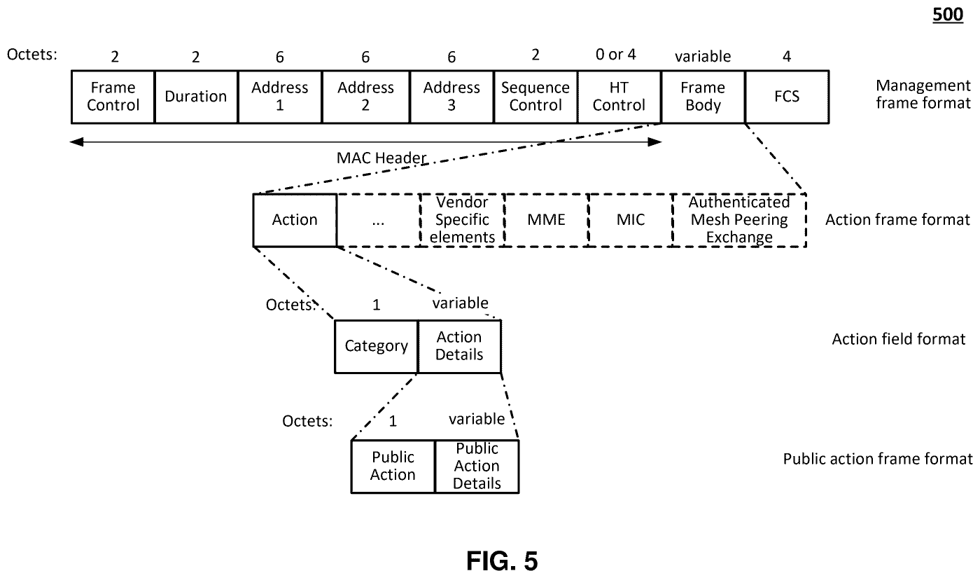

FIG. 5 illustrates an example management frame 500 used as an action frame. In example, management frame 500 includes a MAC header, a variable length frame body, and a frame check sequence (FCS). The MAC header includes a frame control field, a duration field, an address 1 field, an address 2 field, an address 3 field, a sequence control field, and an optional HT control field. The presence of the HT control field is determined by the setting of a +HTC subfield of the frame control field.

As shown in FIG. 4, when used as an action frame, the frame body of management frame includes an action field, vendor specific elements, Management message integrity code element (MME), message integrity code (MIC), and the authenticated mesh peering exchange element.

The action field includes a category field and an action details field. The action field provides a mechanism for specifying extended management actions. The category field indicates a category of the action frame. The action details field contains the details of the action. For example, the action frame may be a public action frame. As shown in FIG. 5, in the public action frame format, the action details field includes a public action field, in the octet immediately after the category field, followed by a variable length public action details field.

One or more vendor specific elements are optionally present. These elements are absent when the category subfield of the Action field is vendor-specific.

The MME is present when management frame protection is negotiated, the frame is a group addressed robust Action frame, and (MBSS only) the category of the action frame does not support group addressed privacy as indicated by category values; otherwise not present.

The MIC element is present in a self-protected action frame if a shared pairwise master key (PMK) exists between the sender and recipient of this frame; otherwise not present.

The authenticated mesh peering exchange element is present in a self-protected action frame if a shared PMK exists between the sender and recipient of this frame; otherwise not present.

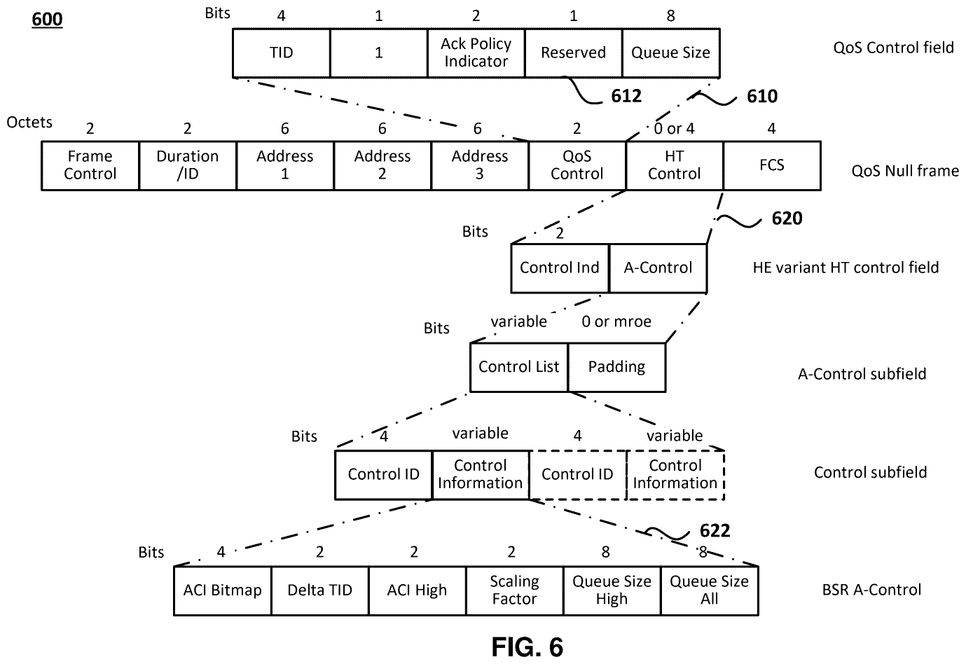

FIG. 6 illustrates an example data frame 600 as a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an acknowledgement (Ack) policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the Ack policy followed upon delivery of the MPDU (e.g., normal Ack, implicit block Ack request, no Ack, block Ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine the TXOP duration assigned to the STA or to determine the uplink (UL) resources assigned to the STA.

In a frame sent by or to a non-high efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, QS, from a received QoS control field, which contains a scaling factor, SF, and an unscaled value, UV, as follows:
QS=
   16×UV, if SF is equal to 0;
   1024+256×UV, if SF is equal to 1;
   17 408+2048×UV, if SF is equal to 2;
   148 480+32 768×UV, if SF is equal to 3 and UV is less than 62;
   >2 147 328, if SF equal to is 3 and UV is equal to 62;
   Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include an aggregated control (A-Control) subfield. The A-Control subfield may include a control list subfield including one or more control subfields. The control subfield may be a BSR control subfield, which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

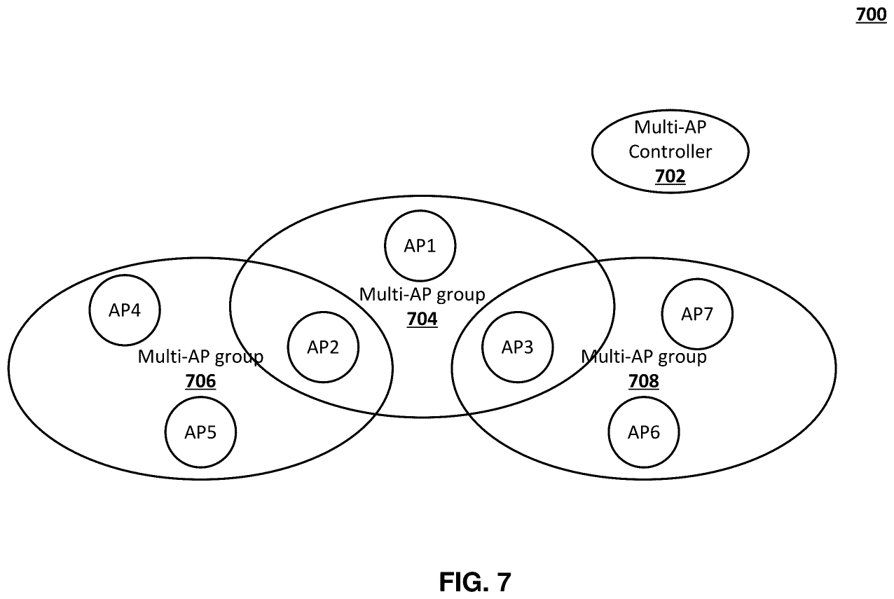

FIG. 7 illustrates an example multi-AP network 700. Example multi-AP network 700 may be a multi-AP network in accordance with the Wi-Fi Alliance standard specification for multi-AP networks. As shown in FIG. 7, multi-AP network 700 may include a multi-AP controller 702 and a plurality of multi-AP groups (or multi-AP sets, or AP candidate sets), including multi-AP group 704, multi-AP group 706, and multi-AP group 708.

Multi-AP controller 702 may be a logical entity that implements logic for controlling the APs in multi-AP network 700. Multi-AP controller 702 may receive capability information and measurements from the APs and may trigger AP control commands and operations on the APs. Multi-AP controller 702 may also provide onboarding functionality to onboard and provision APs onto multi-AP network 700.

Multi-AP group 704, multi-AP group 706, and multi-AP group 708 may each include a plurality of APs. APs in a multi-AP group are in communication range of each other. However, the APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP's beacon frames.

In one approach, one of the APs in a multi-AP group may be designated as a master AP. The designation of the master AP may be done by multi-AP controller 702 or by the APs of the multi-AP group. The master AP of a multi-AP group may be fixed or may change over time between the APs of the multi-AP group. An AP that is not the master AP of the multi-AP group is known as a slave AP.

In one approach, a multi-AP group or an AP candidate set is a set of APs that can initiate or participate in multi-AP coordination. An AP in a multi-AP group can participate as a slave AP in multi-AP coordination initiated by a master AP in the same multi-AP group. At least one AP in a multi-AP group shall be capable of being a master AP.

In one approach, APs in a multi-AP group may coordinate with each other, including coordinating transmissions within the multi-AP group. One aspect of coordination may include coordination to perform multi-AP transmissions within the multi-AP group. As used herein, a multi-AP transmission is a transmission event in which multiple APs (of a multi-AP group or a multi-AP network) transmit simultaneously over a period. The period of simultaneous AP transmission may be a continuous period.

Multi-AP group coordination may be enabled by the multi-AP controller and/or by the master AP of the multi-AP group. In one approach, the multi-AP controller and/or the master AP may control time and/or frequency sharing in a TXOP. For example, when one of the APs (e.g., the master AP) in the multi-AP group obtains a TXOP, the multi-AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

Multi-AP operation may be enabled by at least two APs that support multi-AP coordination within one or more multi-AP groups. The APs may support multi-AP transmission schemes in a multi-AP network. A master AP may coordinate with slave AP(s) to enable multi-AP coordination and to support a multi-AP transmission. Slave AP(s) may participate in a multi-AP transmission. The master AP may select the slave AP(s) which are suitable for the multi-AP transmission. Slave APs may be candidates for a multi-AP transmission before being designated by the master AP.

Multi-AP transmission schemes may include transmission schemes such as coordinated OFDMA, coordinated time division multiple access (TDMA), coordinated spatial reuse, coordinated beamforming, joint transmission or reception (JT/JR), or a combination of two or more of the aforementioned schemes.

Coordinated OFDMA and coordinated TDMA may be categorized as coordinated TXOP, in which frequency or time resources of a TXOP may be used to coordinate the interference. Coordinated spatial reuse (CSR) may provide reuse of spatial domain of neighboring BSSs by adjusting the transmit powers of coordinated APs. Coordinated beamforming (CBF) may provide dedicated null steering with spatial radiation based on channel state information (CSI) feedback from coordinated APs with the aid of multiple antennas to suppress the interference. JT/JR may use distributed MIMO precoding or detection, via shared CSI, for data streams among multiple APs.

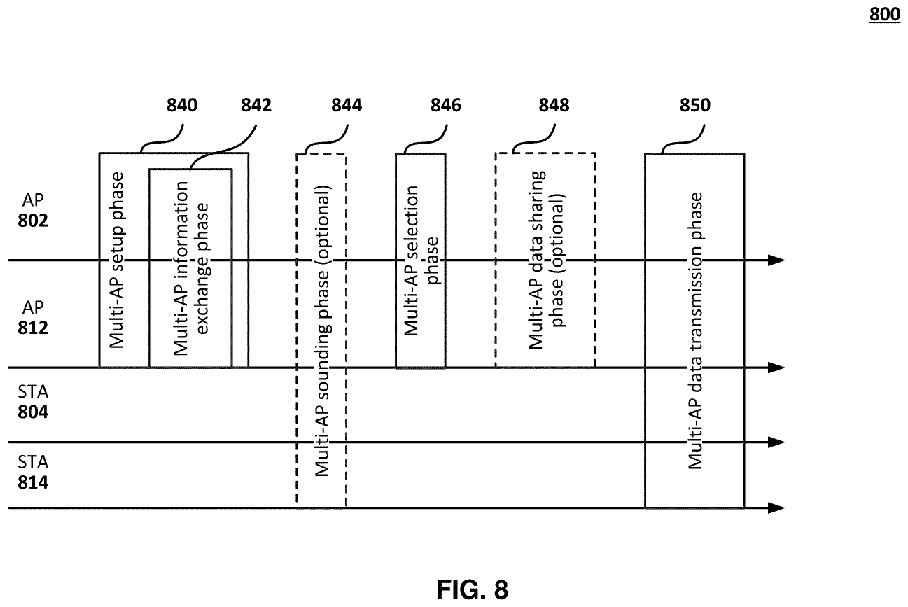

FIG. 8 illustrates an example multi-AP operation 800. Multi-AP operation 800 is illustrated with respect to a multi-AP network that includes AP 802, AP 812, STA 804, and STA 814. In an example, AP 802 and AP 812 may form a multi-AP group. AP 802 may be the master AP and AP 812 may be a slave AP of the multi-AP group. For example, AP 802 may obtain a TXOP making it the master AP of the multi-AP group. Alternatively, AP 802 may be designated as the master AP by a multi-AP controller.

As shown in FIG. 8, multi-AP operation 800 may include a series of phases in time, each of which may contain a plurality of frame exchanges within the multi-AP network. Specifically, multi-AP operation 800 may include a multi-AP setup phase 840, a multi-AP information exchange phase 842, an optional multi-AP sounding phase 844, a multi-AP selection phase 846, an optional multi-AP data sharing phase 848, and a multi-AP data transmission phase 850.

Multi-AP setup phase 840 may include the initialization and setup for multi-AP operation 800. During this phase, APs may transmit frames to notify of their availability and exchange information that may be required for establishing a multi-AP group. For example, in phase 840, AP 802 and AP 812 may broadcast frames, for example, beacon frames, which may be received by each other. In beacon frames, AP 802 and AP 812 may include information regarding AP capability. In an implementation, the AP capability information may include information regarding whether the AP supports multi-AP operation 800.

Multi-AP information exchange phase 842 may be used to exchange information related to multi-AP network operation, including BSS information of APs and link quality information between each AP and its associated STAs, for example. The BSS information of an AP may include a BSS ID of the BSS of the AP, identifiers and/or capabilities of STAs belonging to the BSS, information regarding sounding capabilities of the STAs, buffer status information associated with the BSS of AP, MIMO configuration of AP, etc. In an implementation, multi-AP information exchange phase 842 may be part of multi-AP setup phase 840. Link quality information may include received signal strength indicator (RSSI), signal-to-noise ratio (SNR), signal-to-interference-plus-noise-ratio (SINR), channel state information (CSI), channel quality indicator (CQI).

Multi-AP sounding phase 844 may include procedures for multi-AP channel sounding, including channel estimation and feedback of channel estimates among the master AP, candidate slave AP(s), and associated STAs. Multi-AP sounding phase 844 may be optional for some multi-AP transmission schemes. For example, multi-AP sounding phase 844 may be optional for coordinated spatial reuse (CSR) as channel information is not required.

Multi-AP selection phase 846 may include procedures for soliciting, selecting, or designating slave AP(s) for a multi-AP group by a master AP. Multi-AP selection phase 846 may include the same procedures for reselecting another candidate slave AP, when a candidate slave AP being solicited is not available during the selection.

Multi-AP data sharing phase 848 may include procedures for sharing the data frames to be transmitted to associated STAs among the master AP and designated slave AP(s) via direct connections between APs. Multi-AP data sharing phase 848 may be optional for some multi-AP data transmission schemes. For example, multi-AP data sharing phase 848 may be required for JT/JR as data frames may be exchanged between APs before or after the multi-AP data transmission phase 850. In another example, multi-AP data sharing phase 848 may not be required for CSR or coordinated beamforming (CBF).

Multi-AP data transmission phase 850 may include exchange of data frames between the master AP, designated slave AP(s), and their associated STAs based on multi-AP transmission scheme(s) determined by the master AP. Depending on the multi-AP transmission scheme(s) to be used, multi-AP data transmission phase 850 may include optional synchronization between APs within the multi-AP group before exchanging data frames between APs and STAs within the multi-AP network.

In other examples, the order of phases of FIG. 8 may be different. Further, as mentioned above, some phases may be optional and may or may not be present. For example, optional multi-AP sounding phase 844 may not be required for CSR. However, optional multi-AP data sharing phase 848 may be required for JT/JR. Further, in JT, multi-AP data sharing phase 848 may occur prior to multi-AP data transmission phase 850, whereas, in JR, phase multi-AP data sharing phase 848 may occur after multi-AP data transmission phase 850. In an implementation, multi-AP setup phase 840, multi-AP information exchange phase 842, and multi-AP sounding phase 844 may be operated as long-term procedures. For example, a long-term procedure may be effective for one or more beacon intervals. In an implementation, multi-AP selection phase 846, multi-AP data sharing phase 848, and multi-AP data transmission phase 850 may be operated as short-term procedures. For example, a short-term procedure may be effective for one or more TXOP durations.

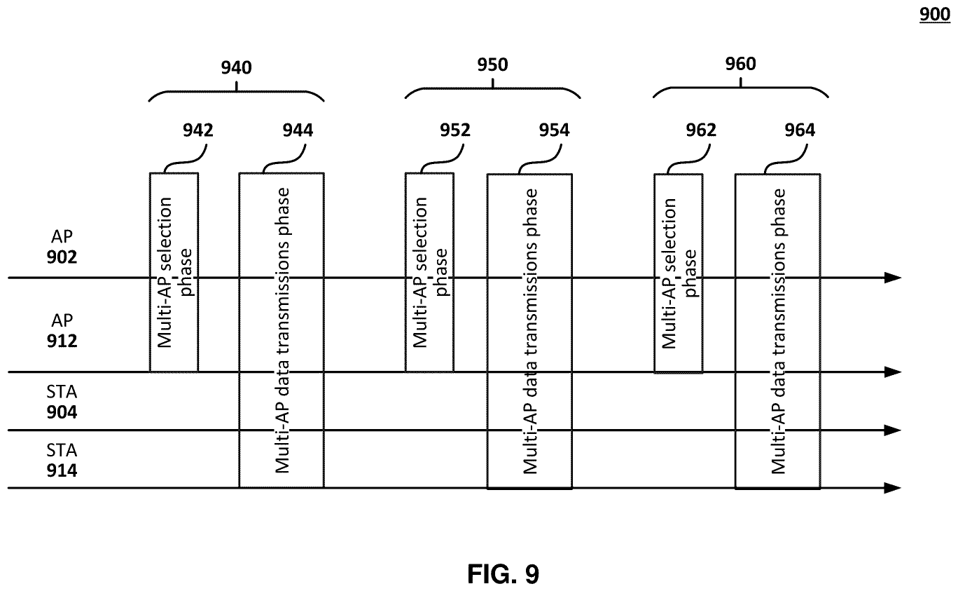

FIG. 9 illustrates an example operation 900 using a plurality of repeated procedure pairs. Multi-AP operation 900 is illustrated with respect to a multi-AP network that includes AP 902, AP 912, STA 904 and STA 914. In an example, AP 902 and AP 912 may form a multi-AP group. AP 902 may be the master AP and AP 912 may be a slave AP of the multi-AP group. For example, AP 902 may obtain a TXOP making it the master AP of the multi-AP group. Alternatively, AP 902 may be designated as the master AP by a multi-AP controller.

As illustrated by FIG. 9, the plurality of procedure pairs may include procedure pair 940, procedure pair 950, and procedure pair 960 of multi-AP selection phase 942, multi-AP selection phase 952, and multi-AP selection phase 962, and multi-AP data transmission phase 944, multi-AP data transmission phase 954, and multi-AP data transmission phase 964 operated for multi-AP transmission. In an example, multi-AP selection phase 942, multi-AP selection phase 952, and multi-AP selection phase 962 may be examples of multi-AP selection phase 846 of FIG. 8. In an example, multi-AP data transmission phase 944, multi-AP data transmission phase 954, and multi-AP data transmission phase 964 may be examples of multi-AP data transmission phase 850 of FIG. 8. In an implementation, procedure pair 940, procedure pair 950, and procedure pair 960 may be operated as short-term procedures. In an implementation, procedure pair 940, procedure pair 950, and procedure pair 960 may be operated after multi-AP operation 800 of FIG. 8.

As shown in FIG. 9, the multi-AP selection multi-AP selection phase 942 and multi-AP data transmission phase 944 in procedure pair 940 may be repeated as procedure pair 950 and procedure pair 960, in order to select the AP 912 in different periods each time before the next multi-AP transmission. However, the overhead may be increased by repeated phases multi-AP selection phase 952 and multi-AP selection phase 962.

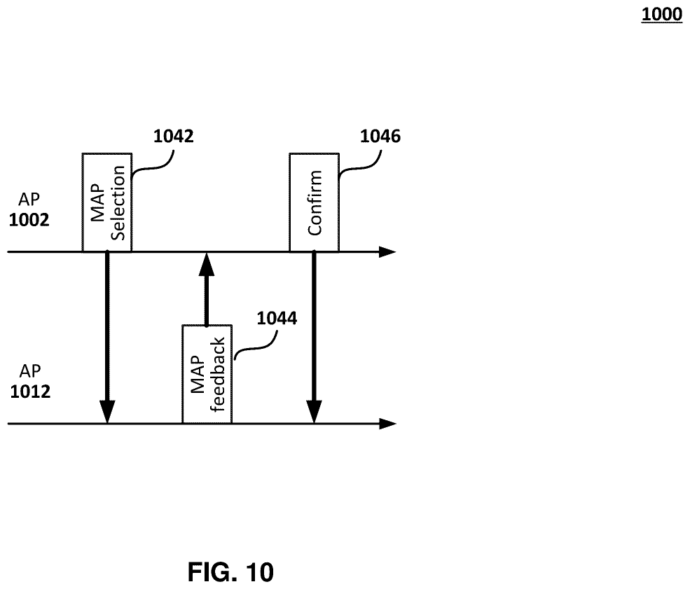

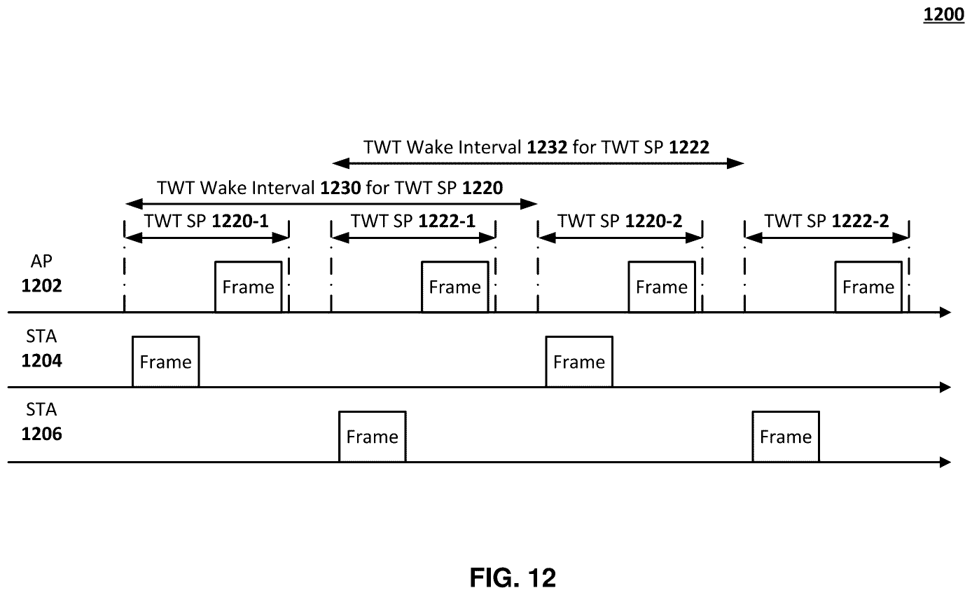

FIG. 10 illustrates an example multi-AP selection phase 1000. Multi-AP selection phase 1000 may be an example of multi-AP selection phase 846. As shown in FIG. 12, example multi-AP selection phase 1000 may include a master AP 1002 and a slave AP 1012 of a multi-AP group.

As shown in FIG. 10, multi-AP selection phase 1000 may include frame exchanges to allow master AP 1002 to determine whether candidate slave AP 1012 may participate in a multi-AP transmission. For example, AP 1002 may transmit a frame 1042 including information regarding selection for a multi-AP transmission to AP 1012. In an example, frame 1042 may be a control frame, e.g., a trigger frame. For example, frame 1042 is a multi-AP trigger frame. In another example, frame 1042 may be an action frame, e.g., a public action frame. For example, frame 1042 is a multi-AP selection frame. Frame 1042 may include content requesting information related to the buffer status of AP 1012. Frame 1042 may also include antenna or stream information of AP 1012.

In response to frame 1042, AP 1012 may transmit a frame 1044 to AP 1002. If AP 1012 is available to participate in the multi-AP transmission, frame 1044 may include information related to buffer status and available frequency resources of AP 1012. In an example, when frame 1042 is a trigger frame, e.g., a multi-AP trigger frame, frame 1044 may be a data frame that is included in a trigger-based (TB) PPDU in response to the trigger frame. In another example, when frame 1042 is a public action frame, e.g., a multi-AP selection request frame, frame 1044 may be a multi-AP selection response frame.

If AP 1012 is unavailable to transmit frame 1044 in response to frame 1042, AP 1002 may solicit another slave AP for selection for the multi-AP transmission.

Based on receiving frame 1044, AP 1002 may confirm AP 1012 as a designated AP for the multi-AP transmission by transmitting a frame 1046.

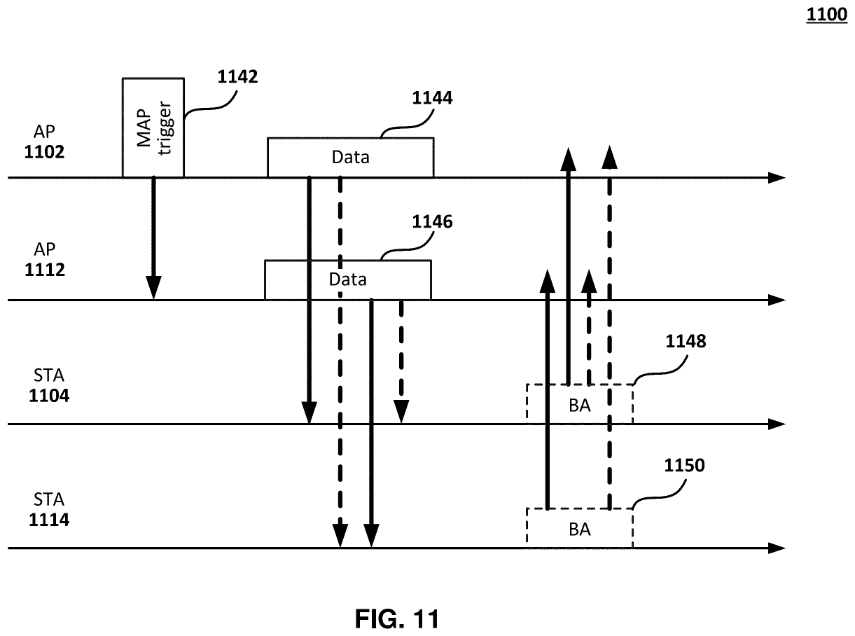

FIG. 11 illustrates an example multi-AP data transmission phase 1100. Multi-AP data transmission phase 1100 may be an example of multi-AP data transmission phase 850 of FIG. 8. As shown in FIG. 11, example multi-AP data transmission phase 1100 may include a master AP 1102 and a slave AP 1112 of a multi-AP group. Example multi-AP data transmission phase 1100 may further include a STA 1104 associated with AP 1102, and a STA 1114 associated with AP 1012.

As shown in FIG. 11, multi-AP data transmission phase 1100 may include frame exchanges to enable master AP 1002 to coordinate with designated slave AP 1112 to perform specific multi-AP transmission schemes with their associated STAs. For example, master AP 1102 and slave AP 1112 may perform multi-AP transmission schemes with STAs 1104 and 1114, respectively. The multi-AP transmission schemes may include coordinated OFDMA, coordinated time division multiple access (TDMA), coordinated spatial reuse, coordinated beamforming, joint transmission or reception (JT/JR), or a combination of two or more of the aforementioned schemes.

As shown in FIG. 11, master AP 1102 may begin multi-AP data transmission phase 1100 by transmitting a frame 1142 to AP 1112. Frame 1142 may include information related to AP 1112 (e.g., an identifier of AP 1112), synchronization information, information related to a specific multi-AP transmission scheme to be used, and/or information related to an RU for use by AP 1112 to acknowledge frame 1142. Frame 1142 may be a control frame. For example, frame 1142 may be a multi-AP trigger frame.

Slave AP 1112 may receive frame 1142 and may use the synchronization information to synchronize with master AP 1102. Subsequently, AP 1102 and AP 1112 may perform data transmission to their associated STA 1104 and AP 1114, respectively. Specifically, AP 1102 may transmit a data frame 1144 to its associated STA 1104, and AP 1112 may transmit a data frame 1146 to its associated STA 1114. Depending on the multi-AP transmission scheme being used, frame 1144 and frame 1146 may also be transmitted by AP 1102 and AP 1112 respectively to STAs in different BSSs. For example, when the multi-AP transmission scheme is JT/JR, AP 1102 may also transmit frame 1144 to STA 1114 associated with slave AP 1112, and AP 1112 may also transmit frame 1146 to STA 1104 associated with AP 1102. The resources for transmitting and receiving frame 1144 and frame 1146 may depend on the specific multi-AP transmission scheme adopted.

STA 1104 and STA 1114 may acknowledge frame 1144 and frame 1146, respectively. For example, STA 1104 may transmit a frame 1148 to AP 1102, and STA 1114 may transmit a frame 1150 to AP 1102. Frame 1148 and frame 1150 may be BlockAck (BA) frames. the multi-AP transmission scheme used requires so, STA 1104 and STA 1114 may also transmit frame 1148 and frame 1150 to APs in different BSSs. For example, when the multi-AP transmission scheme is JT/JR, STA 1104 may also transmit frame 1148 to AP 1112, and STA 1114 may also transmit frame 1150 to AP 1102. The resources for transmitting and receiving frame 1148 and frame 1150 may depend on the specific multi-AP transmission scheme adopted.

As previously discussed in reference to FIG. 8, multi-AP selection phase 848 and multi-AP data transmission phase 850 may be carried out as short-term procedures. For example, each phase may be effective within one or more TXOP durations. For example, the APs in a multi-AP group (or an AP candidate set) may be available to participate in multi-AP transmission when multi-AP selection phase and multi-AP data transmission phase are operated in a same TXOP. When the multi-AP selection phase and the multi-AP data transmission phase are operated in different TXOPs, the AP being available to be designated from the multi-AP group in the multi-AP selection phase during a TXOP may no longer be available to participate in multi-AP transmission in the multi-AP data transmission phase during another TXOP.

An AP may become unavailable to participate in a multi-AP transmission due to different reasons. For example, an AP may be unavailable for multi-AP transmission because the AP has a scheduled target wake time (TWT) service period (SP) with an associated STA. The TWT SP may be used for single-AP transmission with the STA. The STA may transmit to or receive from the AP during the scheduled TWT SP.

TWT, a feature introduced in the IEEE 802.11ah standard, allows STAs to manage activity in the BSS by scheduling STAs to operate at different times to reduce contention. TWTs may allow STAs to reduce the required amount of time that a STA utilizing a power management mode may be awake. TWTs may be individual TWTs or broadcast TWTs. Individual TWTs follow a negotiated TWT agreement between STAs. Broadcast TWTs are based on a schedule set and provided to STAs by an AP.

A TWT session may be negotiated between an AP and a STA. The TWT session may configure a TWT SP of DL and UL traffic between the AP and the STA. Expected traffic may be limited within the negotiated SP. The TWT SP may start at a specific time. The TWT SP may run for a SP duration. The TWT SP may repeat every SP interval.

FIG. 1200 illustrates an example TWT operation 1200. As shown in FIG. 3, example TWT operation 1200 includes an AP 1202, a STA 1204, and a STA 1206. AP 1202 and STA 1204 may establish a TWT SP 1220. AP 1202 and STA 1206 may establish a TWT SP 1222. TWT SP 1220 and TWT SP 1222 may repeat as shown in FIG. 12, such that TWT SP 1220 may include a first TWT SP 1220-1 and a second TWT SP 1220-2, and such that TWT SP 1222 may include a first TWT SP 1222-1 and a second TWT SP 1222-2.

AP 1202 and STA 1204 may exchange frames during first TWT SP 1220-1. STA 1204 may enter a doze state at the end of TWT SP 1220-1 and may remain in the doze state until the start of second TWT SP 1220-2. The start of second TWT SP 1220-2 may be indicated by a TWT wake interval 1230 associated with TWT SP 1120. AP 1202 and STA 1204 may again exchange frames during second TWT SP 1220-2.

Similarly, AP 1202 and STA 1206 may exchange frames during first TWT SP 1222-1. STA 1206 may enter a doze state at the end of first TWT SP 1222-1 and may remain in the doze state until the start of second TWT SP 1222-2. The start of second TWT SP 1222-2 may be indicated by a TWT wake interval 1232 associated with TWT SP 1222. AP 1202 and STA 1206 may again exchange frames during second TWT SP 1222-2.

In an awake state, a STA may be fully powered. The STA may transmit and/or receive a frame to/from an AP or another STA. In a doze state, a STA may not transmit and may not receive a frame to/from an AP or another STA.

An AP may become unavailable to participate in multi-AP transmission due to different reasons. For example, another reason causing an AP to be unavailable for multi-AP transmission is that the AP may comprise a battery-power AP (e.g., a mobile AP), that is scheduled to enter a power saving mode during a time period. The time period may correspond to a doze state (of the power save mode) in which the AP may not communicate at all. Alternatively, the time period may correspond to a low power consumption state (e.g., a listen state of the power save mode) in which the AP may be limited to receive PPDUs of a certain configuration (e.g., non-HT PPDUs or non-HT duplicate PPDUs), unless solicited to an awake state (of the power save mode) in which the AP may be able to receive PPDUs of any configurations, e.g. highest modulation and coding scheme (MCS), highest bandwidth or highest number of spatial streams.

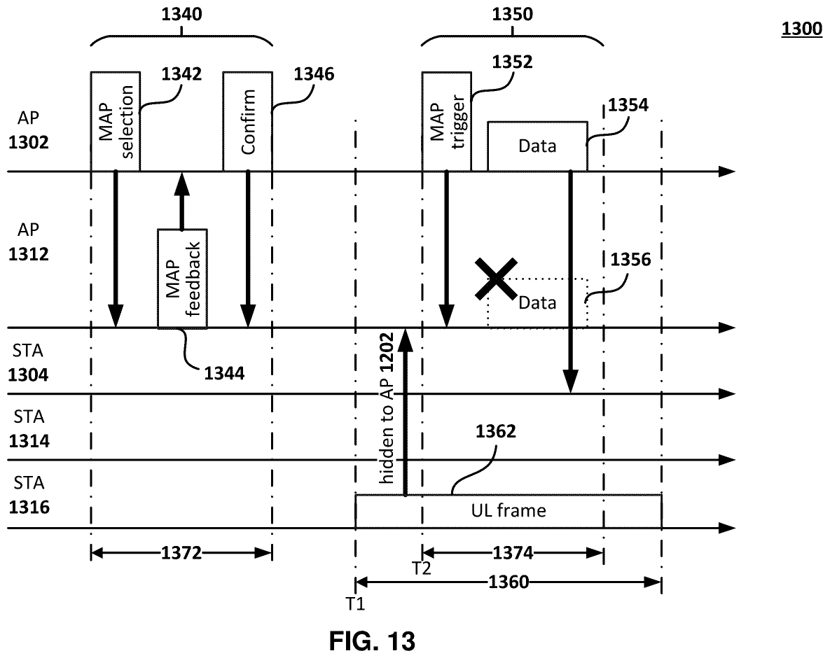

FIG. 13 illustrates an example multi-AP operation 1300 using operations disclosed above. Example multi-AP operation 1300 includes a multi-AP network including a first BSS and a second BSS. The first BSS may include an AP 1302 and a STA 1304. STA 1304 may be associated with AP 1302. The second BSS may include an AP 1312 and a plurality of STAs, STA 1314 and STA 1316. STA 1314 and STA 1316 may be associated with AP 1312. In an example, STA 1316 is hidden from AP 1302. In an example, AP 1302 and AP 1312 may form a multi-AP group. AP 1302 may be the master AP and AP 1312 may be a slave AP of the multi-AP group. For example, AP 1302 may obtain a TXOP making it the master AP of the multi-AP group. Alternatively, AP 1302 may be designated as the master AP by a multi-AP controller.

In an example, as shown in FIG. 13, it is assumed that multi-AP setup phase 840, and multi-AP information exchange phase 842 of FIG. 8 are already completed. In example multi-AP operation 1300, a multi-AP selection phase 1340 is operated during period 1372, while a multi-AP data transmission phase 1350 is operated during period 1374 starting at time T2. In an example, period 1372 and period 1374 are separate apart to each other.

As shown in FIG. 13, example multi-AP operation 1300 may begin with multi-AP selection phase 1340 using the example procedure illustrated in FIG. 10. For example, multi-AP selection phase 1340 may exchange frame 1342, frame 1344, and frame 1346 between AP 1302 and AP 1312. In multi-AP selection phase 1340, master AP 1302 designates slave AP 1312 for a multi-AP transmission.

In an example, STA 1316 may establish a scheduled UL transmission frame 1362 with AP 1312. In an example, AP 1302 may not receive frame 1362. In an example, STA 1316 may start to transmit frame 1362 at time T1 during period 1360. For example, period 1360 may be a TWT SP of transmission between AP 1312 and STA 1316.

As shown in FIG. 13, example multi-AP operation 1300 may start the multi-AP data transmission phase 1350 at time T2. In an example, time T2 occurs after time T1 during period 1360. In multi-AP data transmission phase 1350, AP 1302 may transmit a frame 1352 intending to initiate the data transmissions from AP 1302 and AP 1312 to their associated STAs, STA 1304 and STA 1314, respectively. Frame 1352 may be an example of frame 1142 of FIG. 11. Frame 1352 may be a multi-AP trigger frame. AP 1302 may transmit frame 1354 after transmitting frame 1352. However, AP 1312 which is receiving frame 1362 from STA 1316 during period 1360 cannot transmit frame 1356 after receiving frame 1352. As a result, AP 1312 may fail to perform multi-AP transmission with AP 1302.

In an example, the existing procedures of FIG. 9 may be used to select the AP 1312 in different TXOPs repeatedly. In another example, AP 1302 may reselect another AP. However, repeatedly selecting the same AP or reselecting a different AP may not guarantee the AP 1312 performs multi-AP transmission successfully and may increase extra overhead. For example, the overhead may be a signal overhead.

The problem illustrated in FIG. 13 occurs due to shortcomings in the existing procedures for multi-AP operation. Existing procedures for initiating multi-AP transmissions may result in situations of unsuccessful communication between a participating AP of the multi-AP transmission and a STA. Such situations not only cause inefficient coordination and resource waste for the multi-AP transmission but also may cause a latency increase, throughput decrease, and QoS performance decrease for the multi-AP network.

Accordingly, there is a need in the art for increasing the likelihood that an AP designated to participate in a multi-AP transmission is available when performing the multi-AP transmission.

Embodiments of the present disclosure, as further described below, provide enhanced procedures which may be used to set up, coordinate, perform, and/or update multi-AP transmissions.

In an embodiment, a first AP may transmit to a second AP a first frame comprising information indicating a period for a multi-AP transmission. In an embodiment, the period of the multi-AP transmission may be indicated by a starting time and a duration. In an example, the period of the multi-AP transmission may be a period of time. For example, the period of time may be scheduled in a frequency band or a channel. For example, the channel may be in a frequency domain or in a spatial domain. For example, the period of time may be a period of transmitting or receiving a frame. For example, the period of time may be a period of exchanging frames. In another example, the period of the multi-AP transmission may be a number of transmissions/messages/frames exchanged.

In an example, information indicating a period of the multi-AP transmission may be multi-AP transmission information. For example, the period of the multi-AP transmission may be a multi-AP transmission window. For example, the multi-AP transmission information may be the information about the multi-AP transmission window. For example, the multi-AP transmission window is a window of time when the first AP and the second AP perform the multi-AP transmission.

In an embodiment, the first AP receives from the second AP a second frame indicating a decision by the second AP to participate in the multi-AP transmission based on the first frame.

In an embodiment, the first AP transmits to the second AP a third frame to initiate the multi-AP transmission based on the decision.

The proposed procedures mitigate the above-discussed situations of unsuccessful communications. In one aspect, the proposed procedures reduce such situations, particularly in short-term procedures. As such, coordination efficiency, resource utilization, latency reduction and QoS performance may be improved within the multi-AP network.

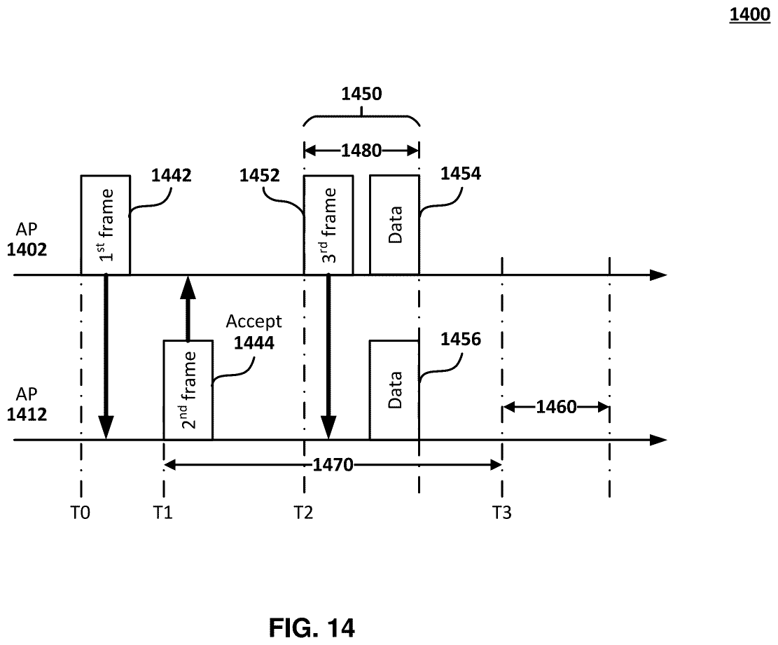

FIG. 14 illustrates an example multi-AP operation 1400 using frame exchanges including information indicating a period for a multi-AP transmission. Example multi-AP operation 1400 is provided for the purpose of illustration only and is not limiting. Example multi-AP operation 1400 includes a plurality of APs, a first AP 1402, and a second AP 1412. In an embodiment, AP 1402 and AP 1412 belong to different basic service sets (BSSs). In an example, AP 1402 and AP 1412 form a multi-AP group. AP 1402 may be the master AP while AP 1412 may be a slave AP of the multi-AP group. For example, AP 1402 may obtain a TXOP making it the master AP of the multi-AP group. Alternatively, AP 1402 may be designated as the master AP by a multi-AP controller. AP 1402 and AP 1412 may exchange frames to set up a multi-AP transmission. In an example, each of AP 1402 and AP 1412 may have one or more associated STAs (not shown in FIG. 14).

For the purpose of illustration, AP 1402 and AP 1412 may exchange a plurality of frames, for example, a first frame 1442, a second frame 1444, and a third frame 1452, during a multi-AP operation procedure. It is assumed, for the purpose of illustration, that the order of frames shown in FIG. 14 may or may not relate to the order of the frames being transmitted by AP 1402 and AP 1412. It is further assumed that AP 1412 is unavailable for participating in multi-AP transmission during a period 1460 starting at time T3.

In an embodiment, AP 1402 transmits first frame 1442 to AP 1412 at time T0. In an example, AP 1412 may be a candidate slave AP that intends to participate in a multi-AP transmission. In an example, AP 1412 may be a designated slave AP that is selected to participate in a multi-AP transmission. Frame 1442 comprises information indicating the period 1480 for a multi-AP transmission. In an embodiment, the information included in frame 1442 may further indicate a starting time T2 and a duration of the period 1480. For example, period 1480 may include the estimated duration of exchanging frames for the multi-AP transmission in phase 1450. Frame 1442 may be a control frame or a management frame.

In an embodiment, AP 1412 may calculate a duration of period 1470 between frame 1444 to be transmitted at time T1 to the starting time T3 of period 1460. In an embodiment, AP 1412 may compare period 1480 to period 1470 or period 1460. As shown in FIG. 14, period 1480 is included in period 1470 and is nonoverlapping with period 1460. Therefore, AP 1412 decides to accept to participate in the multi-AP transmission during phase 1450.

In an embodiment, AP 1402 receives from AP 1412 at time T1 second frame 1444 indicating a decision by AP 1412 to participate in the multi-AP transmission within period 1480 based on the first frame 1442. As shown in FIG. 14, the decision may be acceptance.

In an embodiment, AP 1402 transmits third frame 1452 based on the decision in second frame 1444, to initiate the multi-AP transmission in phase 1450 during period 1480. For example, phase 1450 may be an example of the multi-AP data transmission phase 1100 illustrated in FIG. 11. In an embodiment, phase 1450 includes AP 1402 transmitting third frame 1452 at time T2, AP 1402 transmitting a frame 1454, and AP 1412 transmitting a frame 1456. As shown in FIG. 14, T2 is before the period 1460 starting at time T3. As a result, AP 1412 successfully performs a multi-AP transmission in phase 1450 with AP 1402 during period 1480. Frame 1452 may be a management frame or a control frame.

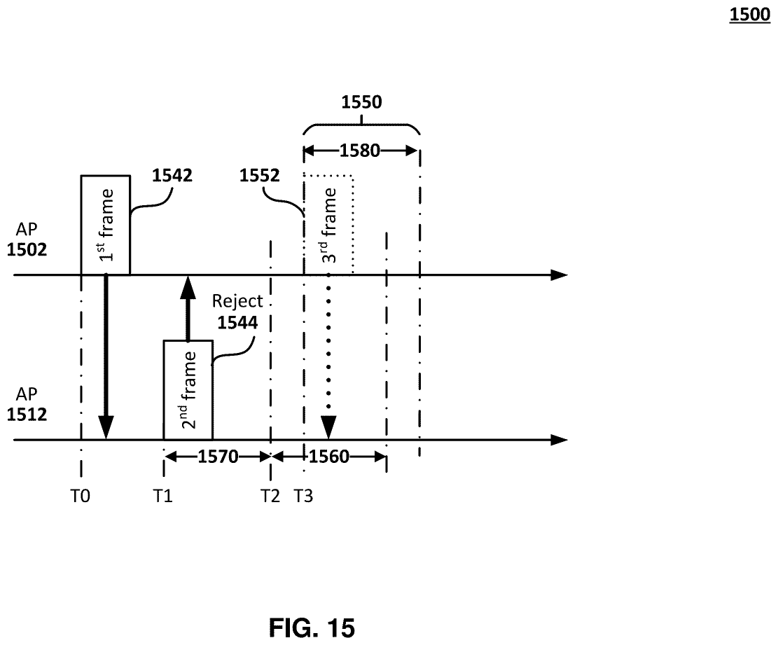

FIG. 15 illustrates an example multi-AP operation 1500 using frame exchanges including information indicating a period for a multi-AP transmission. Example multi-AP operation 1500 is provided for the purpose of illustration only and is not limiting. Example multi-AP operation 1500 includes a plurality of APs, a first AP 1502, and a second AP 1512. In an embodiment, AP 1502 and AP 1512 belong to different basic service sets (BSSs). In an example, AP 1502 and AP 1512 form a multi-AP group. AP 1502 may be the master AP while AP 1512 may be a slave AP of the multi-AP group. For example, AP 1502 may obtain a TXOP making it the master AP of the multi-AP group. Alternatively, AP 1502 may be designated as the master AP by a multi-AP controller. AP 1502 and AP 1512 may exchange frames to set up a multi-AP transmission. In an example, each of AP 1502 and AP 1512 may have one or more associated STAs (not shown in FIG. 14).

For the purpose of illustration, AP 1502 and AP 1512 may exchange a plurality of frames, for example, a first frame 1542, and a second frame 1544, during a multi-AP operation procedure. It is assumed, for the purpose of illustration, that the order of frames shown in FIG. 15 may or may not relate to the order of the frames being transmitted by AP 1502 and AP 1512. It is further assumed that AP 1512 is unavailable for participating in multi-AP transmission during a period 1560 starting at time T2.

In an embodiment, AP 1502 transmits first frame 1542 to AP 1512 at time T0. In an example, AP 1512 may be a candidate slave AP that intends to participate in a multi-AP transmission. In an example, AP 1512 may be a designated slave AP that is selected to participate in a multi-AP transmission. Frame 1542 comprises information indicating the period 1580 for a multi-AP transmission. In an embodiment, the information included in frame 1542 may further indicate a starting time T3 and a duration of the period 1580. For example, period 1580 may include the estimated duration of exchanging frames for the multi-AP transmission in phase 1550. Frame 1542 may be a control frame or a management frame.

In an embodiment, AP 1512 may calculate a duration of period 1570 between frame 1544 to be transmitted at time T1 to the starting time T2 of period 1560. In an embodiment, AP 1512 may compare period 1580 to period 1570 and period 1560. As shown in FIG. 15, period 1580 overlaps with period 1560. Therefore, AP 1512 decides to reject participation in the multi-AP transmission during phase 1550.

In an embodiment, AP 1502 may receive from AP 1512 at time T1, second frame 1544 indicating a decision by AP 1512 participate in the multi-AP transmission within period 1580 based on the first frame 1542. As shown in FIG. 15, the decision may be a rejection.

As shown in FIG. 15, the AP 1502 may not transmit frame 1552 to AP 1512 to initiate the multi-AP transmission within period 1580 based on the decision in frame 1544. As a result, example multi-AP operation 1500 may avoid an unsuccessful multi-AP transmission.

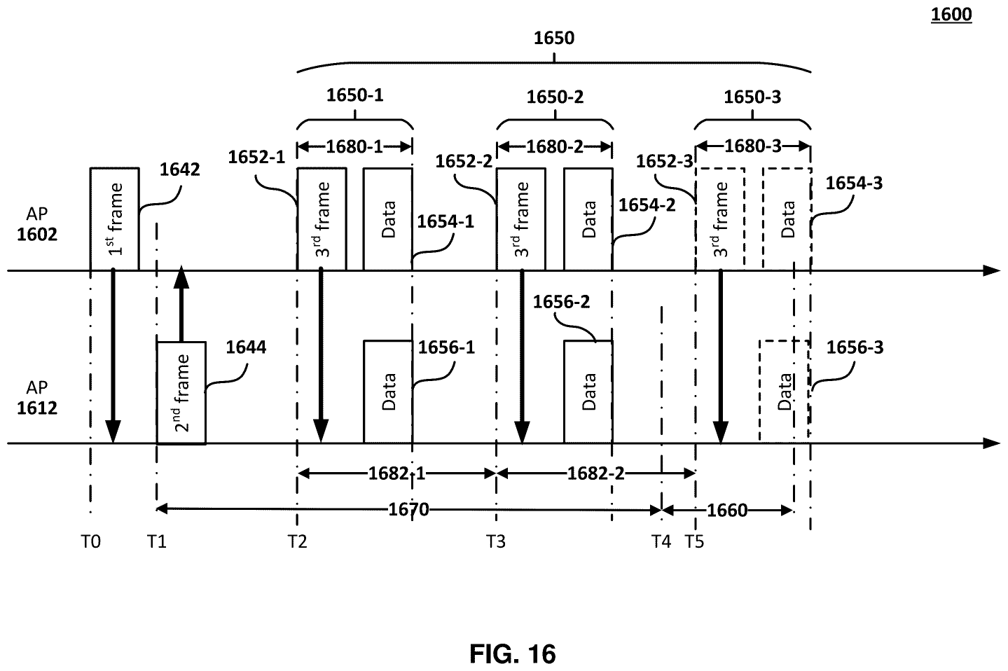

FIG. 16 illustrates an example multi-AP operation 1600 using frame exchanges including information indicating a period for a multi-AP transmission. Example multi-AP operation 1600 is provided for the purpose of illustration only and is not limiting. Example multi-AP operation 1600 includes a plurality of APs, a first AP 1602, and a second AP 1612. In an embodiment, AP 1602 and AP 1612 belong to different basic service sets (BSSs). In an example, AP 1602 and AP 1612 form a multi-AP group. AP 1602 may be the master AP while AP 1612 may be a slave AP of the multi-AP group. For example, AP 1602 may obtain a TXOP making it the master AP of the multi-AP group. Alternatively, AP 1602 may be designated as the master AP by a multi-AP controller. AP 1602 and AP 1612 may exchange frames to set up a multi-AP transmission. In an example, each of AP 1602 and AP 1612 may have one or more associated STAs (not shown in FIG. 16).

For the purpose of illustration, AP 1602 and AP 1612 may exchange a plurality of frames, for example, a first frame 1642, a second frame 1644, a plurality of third frames including a frame 1652-1, a frame 1652-2, and an optional frame 1652-3, during a multi-AP operation procedure. It is assumed, for the purpose of illustration, that the order of frames shown in FIG. 16 may or may not relate to the order of the frames being transmitted by AP 1602 and AP 1612. It is further assumed that AP 1612 is unavailable for participating in multi-AP transmission during a period 1660 starting at time T4.

In an embodiment, the period for the multi-AP transmission may include a plurality of periods of multi-AP transmissions. As shown in FIG. 16, AP 1602 may intend to initiate a plurality of periods 1680 (which include period 1680-1, period 1680-2, and period 1680-3) for multi-AP transmissions in a plurality of phases 1650. In an example, a plurality of periods may include a period 1680-1 starting at T2, a period 1680-2 starting at T3, and an optional period 1680-3 starting at T5. As shown in FIG. 16, a plurality of phases 1650 may include a phase 1650-1, a phase 1650-2, and an optional phase 1650-3, each of which may be an example of multi-AP data transmission phase 1100 in FIG. 11. In an example, period 1680-2 starts at time T3 after an offset 1682-1 in reference to period 1680-1 starting at time T2. In another example, period 1680-3 starts at time T5 after an offset 1682-2 in reference to period 1680-2 starting at time T3. In an example, the plurality of periods 1680 may be periodic, wherein offset 1682-1 and offset 1682-2 use the same value. In an implementation, the durations of period 1680-1, period 1680-2, and period 1680-3 may use the same value. In an example, the plurality of periods 1680 may be without periodicity. In an implementation, offset 1682-1 and offset 1682-2 may use the same value or different values. In an implementation, the durations of period 1680-1, period 1680-2, and period 1680-3 may use the same value or different values.

In an embodiment, AP 1602 transmits first frame 1642 to AP 1612 at time T0. In an example, AP 1612 may be a candidate slave AP that intends to participate in a multi-AP transmission. In an example, AP 1612 may be a designated slave AP that is selected to participate in a multi-AP transmission. Frame 1642 comprises information indicating the plurality of periods 1680 of multi-AP transmissions in a plurality of phases 1650. In an embodiment, the information included in frame 1642 may further indicate starting time T2, a duration of period 1680-1. In an embodiment, the information included in frame 1644 may further indicate a value of offset 1682-1 for a periodicity for a plurality of periods 1680. In an embodiment, the information further indicates one offset value between the plurality of periods 1680. For example, the values of offset 1682-1 and offset 1682-2 are the same. In an embodiment, the information further indicates two or more offset values between the plurality of periods 1680. For example, the values of offset 1682-1 and offset 1682-2 are different. In an embodiment, the information further indicates two or more durations of period 1680-1, period 1680-2, and period 1680-3. For example, durations of period 1680-1, period 1680-2, and period 1680-3 are different. In an embodiment, the information further indicates a number of periods (e.g., three) included in the plurality of periods 1680. Frame 1642 may be a data frame or a management frame.

In an embodiment, AP 1602 may calculate a duration of period 1670 between frame 1644 to be transmitted at time T1 to the starting time T2 of the plurality of periods 1680. In an embodiment, AP 1602 may compare the plurality of periods 1680 to period 1670 and period 1660, and determine to participate in the multi-AP transmission during phase 1650. As shown in FIG. 16, period 1680-3 overlaps with period 1660. In an example, when a plurality of periods 1680 are periodic, the plurality of periods 1680 overlap with period 1660. Therefore, AP 1612 decides to reject. In an example, when a plurality of periods 1680 is non-periodic and period 1680-3 is present, the plurality of periods 1680 overlap with period 1660. Therefore, AP 1612 decides to reject. In another example, when a plurality of periods 1680 is non-periodic and period 1680-3 is absent, the plurality of periods 1680 is nonoverlapping with the period 1660. Therefore, AP 1612 decides to accept.

In an embodiment, AP 1602 receives from AP 1612 at time T1 second frame 1644 indicating a decision by AP 1612 to participate in the multi-AP transmission within the plurality of periods 1680 based on the first frame 1642. As discussed above, the decision may be an acceptance when period 1680-3 is absent, and the decision may be a rejection when period 1680-3 is present.

In an embodiment, AP 1602 transmits third frame 1652-1 based on the second frame 1644, to initiate the multi-AP transmission in phase 1650-1 and phase 1650-2 before period 1660. In an embodiment, phase 1650-1 includes AP 1602 transmitting third frame 1652-1 at time T2, AP 1602 transmitting a frame 1654-1, and AP 1612 transmitting a frame 1656-1. In an embodiment, phase 1650-2 includes AP 1602 transmitting third frame 1652-2 at time T3, AP 1602 transmitting a frame 1654-2, and AP 1612 transmitting a frame 1656-2. In an example, T2 and T3 are before period 1660 starting at time T4. As a result, AP 1612 successfully performs multi-AP transmission in phase 1650-1 and phase 1650-2 with AP 1602 before period 1660. Frame 1652-1 and frame 1652-2 may be a control frame or a management frame. Optionally, phase 1650-3 includes AP 1602 transmitting third frame 1652-3 at time T4, AP 1602 transmitting a frame 1654-3, and AP 1612 transmitting a frame 1656-3.

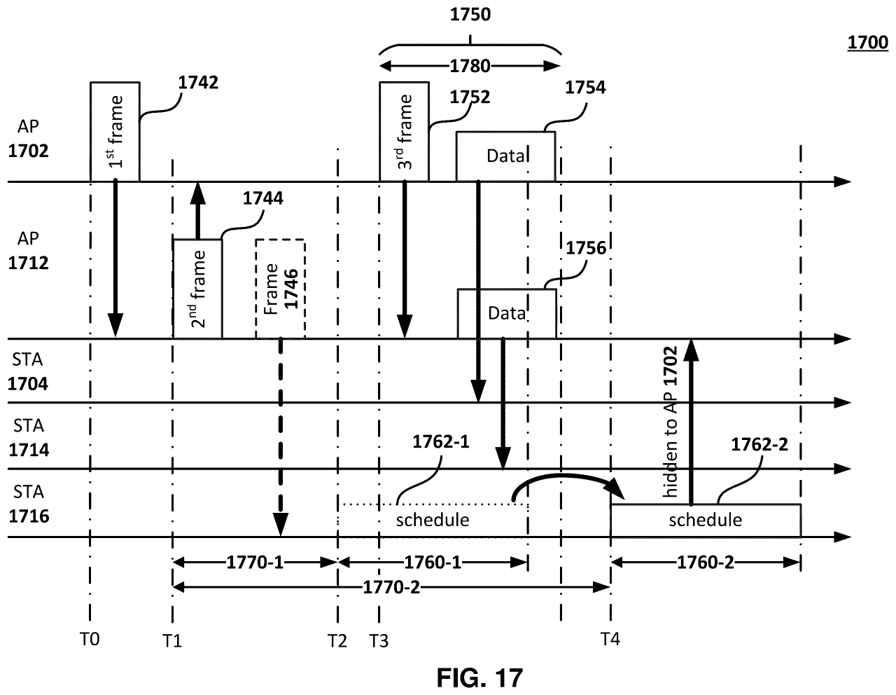

FIG. 17 illustrates an example multi-AP operation 1700 using frame exchanges including information indicating a period for a multi-AP transmission. Example multi-AP operation 1700 is provided for the purpose of illustration only and is not limiting. Example multi-AP operation 1700 includes a multi-AP network including a first BSS and a second BSS. The first BSS may include an AP 1702 and a STA 1704. STA 1704 may be associated with AP 1702. The second BSS may include an AP 1712 and a plurality of STAs, STA 1714 and STA 1716. STA 1714 and STA 1716 may be associated with AP 1712. In an example, STA 1716 is hidden from AP 1702. In an example, AP 1702 and AP 1712 form a multi-AP group. AP 1702 may be the master AP while AP 1712 may be a slave AP of the multi-AP group. For example, AP 1702 may obtain a TXOP making it the master AP of the multi-AP group. Alternatively, AP 1702 may be designated as the master AP by a multi-AP controller. AP 1702 and AP 1712 may exchange frames to set up a multi-AP transmission.

For the purpose of illustration, AP 1702 and AP 1712 may exchange a plurality of frames, for example, a first frame 1742, a second frame 1744, a third frame 1752, during a multi-AP operation procedure. It is assumed, for the purpose of illustration, that the order of frames shown in FIG. 17 may or may not relate to the order of the frames being transmitted by AP 1702 and AP 1712. It is further assumed that AP 1712 is unavailable for participating in multi-AP transmission during a period 1760-1 starting at time T2. In an example, the reason AP 1712 is unavailable during the period 1760-1 may be that AP 1712 may schedule to receive a frame 1762-1 from STA 1716. For example, period 1760-1 may be a TWT SP of transmission between AP 1712 and STA 1716.

In an embodiment, AP 1702 transmits first frame 1742 to AP 1712 at time T0. In an example, AP 1712 may be a candidate slave AP that intends to participate in a multi-AP transmission. In an example, AP 1712 may be a designated slave AP that is selected to participate in a multi-AP transmission. Frame 1742 comprises information indicating the period 1780 for a multi-AP transmission. In an embodiment, the information included in frame 1742 may further indicate a starting time T3 and a duration of the period 1780. For example, period 1780 may include the estimated duration of exchanging frames for the multi-AP transmission in phase 1750. Frame 1742 may be a control frame or a management frame.

In an embodiment, AP 1712 may calculate a duration of period 1770-1 between frame 1744 to be transmitted at time T1 and the starting time T2 of period 1760-1. In an embodiment, AP 1712 may compare period 1780 to period 1770-1 and period 1760-1. As shown in FIG. 17, period 1780 overlaps with period 1760-1.

In an embodiment, AP 1712 may determine whether to reschedule the frame 1762-1 or not. In an example, AP 1712 can reschedule the frame 1762-1 within period 1760-1 to frame 1762-2 within period 1760-2. For example, period 1760-1 is a TWT SP. As shown in FIG. 1700, period 1780 is nonoverlapping with period 1760-2. Therefore, AP 1712 may decide to accept to participate in the multi-AP transmission during phase 1750.

In an embodiment, AP 1702 receives from AP 1712 at time T1, second frame 1744 indicating a decision by AP 1712 participates in the multi-AP transmission within period 1780 based on the first frame 1742. As shown in FIG. 17, the decision may be an acceptance.

In an example, AP 1712 may transmit a frame 1746 to STA 1716 to reschedule frame 1762-1 within period 1760-1 to frame 1762-2 within period 1760-2. Frames 1744 and 1746 may be the same frame or aggregated frames. For example, frame 1744 and frame 1746 may be a broadcast frame or a groupcast frame. In an example, frame 1744 and frame 1746 may be different or separate frames. For example, frame 1744 and frame 1746 may be unicast frames.

In an embodiment, AP 1702 transmits third frame 1752 based on the decision in second frame 1744, to initiate the multi-AP transmission in phase 1750 during period 1780. For example, phase 1750 may be an example of multi-AP data transmission phase 1100 in FIG. 11. In an embodiment, phase 1750 includes AP 1702 transmitting third frame 1752 at time T3, AP 1702 transmitting a frame 1754, and AP 1712 transmitting a frame 1756. As shown in FIG. 17, T3 is before the period 1760-2 starting at time T4. As a result, AP 1712 successfully performs multi-AP transmission in phase 1750 with AP 1702 during period 1780. Frame 1752 may be a management frame or a control frame.

In another example, AP 1712 may not be able to reschedule the period 1760-1. As a result, AP 1712 may decide to reject to participate in the multi-AP transmission during phase 1750. In an embodiment, AP 1702 may receive from AP 1712 at time T1, second frame 1744 indicating a decision by AP 1712 participates in the multi-AP transmission within period 1780 based on the first frame 1742. In an example, the decision may be a rejection (not shown in FIG. 17). AP 1702 may not transmit frame 1752 to AP 1712 to initiate the multi-AP transmission within period 1780 based on the decision in frame 1744. As a result, example multi-AP operation 1700 may avoid an unsuccessful multi-AP transmission.

As mentioned above, first frame 1442 of FIG. 14, first frame 1542 of FIG. 15, and first frame 1642 of FIG. 16 may include control frames or management frames.

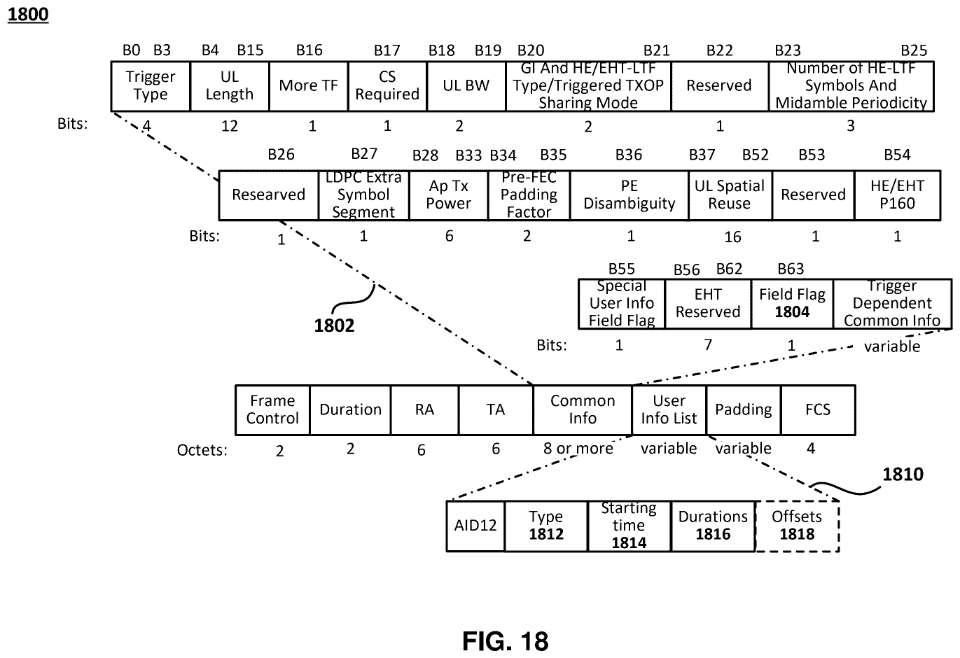

In an embodiment, first frame 1442 of FIG. 14, first frame 1542 of FIG. 15, and first frame 1642 of FIG. 16 may include control frames, such as trigger frames. FIG. 18 illustrates an example trigger frame 1800 including information indicating a period for a multi-AP transmission. As shown in FIG. 18, trigger frame 1800 may include a common info field 1802 and a user info list field 1810.

In an embodiment, trigger frame 1800 may be used for soliciting the second AP to participate in the multi-AP transmission within the period for the multi-AP transmission. In an embodiment, the user info list field 1810 of trigger frame 1800 may include the information indicating the period for the multi-AP transmission. For example, user info list field 1810 may be a multi-AP transmission info field. In an embodiment, as shown in FIG. 18, the common info field 1802 may include a field flag field 1804 indicating the presence of user info list field 1810 used in the user info list field 1802. In an embodiment, the common info field 1802 may include the information, and the format of subfields for the information may be the same as the subfields in user info list field 1810 (not shown in FIG. 18).

In an embodiment, user info list field 1810 may include a subfield 1812 for a type of the period for multi-AP the transmission, a subfield 1814 for a starting time of the period for the multi-AP transmission, and a subfield 1816 for a duration of the period of the multi-AP transmission.

In an embodiment, user info list field 1810 may further include information indicating a plurality of periods of multi-AP transmissions. In an example, the user info list field 1810 may include a subfield 1812 for a type of a plurality of periods of multi-AP transmissions, a subfield 1814 for a starting time of a plurality of periods of multi-AP transmissions, a subfield 1816 for one or more durations of periods of multi-AP transmissions, and an optional subfield 1818 for one or more offsets between the plurality of periods of multi-AP transmissions.

In an implementation, subfield 1812 may be set to 0 to indicate a period for a multi-AP transmission, or may be set to 1 to indicate a plurality of periods of multi-AP transmissions with a periodicity, or may be set to a number larger than 1 to indicate a plurality of periods of multi-AP transmissions without periodicity. In an example, subfield 1814 may be a timeout value in milliseconds for the starting time. In an example, subfield 1816 may be a time duration value in milliseconds. In an implementation, subfield 1816 may be one value when the durations of the plurality of periods of multi-AP transmissions are the same. In an implementation, subfield 1816 may be multiple values when the durations of the plurality of periods of multi-AP transmissions are different. In an example, subfield 1818 may be an offset value in milliseconds. In an implementation, subfield 1818 may be one value when the offsets of the plurality of periods of multi-AP transmissions are the same. In an implementation, subfield 1818 may be multiple values when the offsets of the plurality of periods of multi-AP transmissions are different.

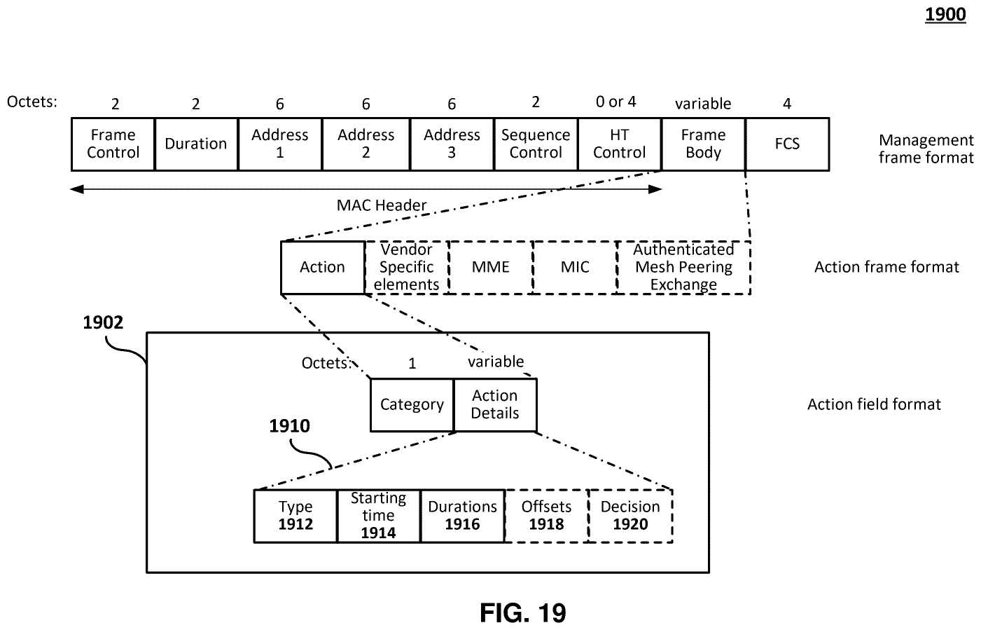

In an embodiment, frame 1442 and 1444 of FIG. 14, frame 1542 and 1544 of FIG. 15, and frame 1642 and frame 1644 of FIG. 16 may be management frames, such as action frames. FIG. 19 illustrates an example action frame 1900 including information indicating a period for a multi-AP transmission.

As shown in FIG. 19, action frame 1900 may include an action field 1902. In an embodiment, the action field 1902 may include information indicating a period for a multi-AP transmission. The action field 1902 may include an action details field 1910.

In an embodiment, the action details field 1910 may include information indicating a period for a multi-AP transmission. In an example, the action details field 1910 may include a subfield 1912 for a type of the period of the multi-AP transmission, a subfield 1914 for a starting time of the period of the multi-AP transmission, a subfield 1916 for a duration of the period of the multi-AP transmission, and an optional subfield 1920 for the decision of a first AP to accept or reject, for a second AP to participate in a multi-AP transmission.

In an embodiment, the action details field 1910 may further include information indicating a plurality of periods for multi-AP transmissions. In an example, the action details field 1910 may include a subfield 1912 for a type of a plurality of periods for multi-AP transmissions, a subfield 1914 for a starting time of a plurality of periods for multi-AP transmissions, a subfield 1916 for one or more durations of periods for multi-AP transmissions, an optional subfield 1918 for one or more offsets between the plurality of periods multi-AP transmissions, an optional subfield 1920 for the decision of a second AP to accept or reject, to participate in a plurality of periods for multi-AP transmissions.

In an implementation, subfield 1912 may be set to 0 to indicate a period for a multi-AP transmission, or may be set to 1 to indicate a plurality of periods of multi-AP transmissions with a periodicity, or may be set to a number larger than 1 to indicate a plurality of periods of multi-AP transmissions without periodicity. In an example, subfield 1914 may be a timeout value in milliseconds for the starting time. In an example, subfield 1916 may be a time duration value in milliseconds. In an implementation, subfield 1916 may be one value when the durations of the plurality of periods of multi-AP transmissions are the same. In an implementation, subfield 1916 may be multiple values when the durations of the plurality of periods of multi-AP transmissions are different. In an example, subfield 1918 may be an offset value in milliseconds. In an implementation, subfield 1918 may be one value when the offsets of the plurality of periods of multi-AP transmissions are the same. In an implementation, subfield 1918 may be multiple values when the offsets of the plurality of periods of multi-AP transmissions are different.

In an embodiment, frame 1444 of FIG. 14, frame 1544 of FIG. 15, frame 1644 of FIG. 16, and frame 1744 of FIG. 17 may be data frames. As illustrated by FIG. 6, data frame 600 may include an QoS control field 610 and an HT control field 620. In an embodiment, the QoS control field 610 may include the decision in frame 1444 of FIG. 14, frame 1544 of FIG. 15, frame 1644 of FIG. 16, and frame 1744 of FIG. 17 by second AP to participate in the multi-AP transmission. In an example, the reserved field 612 may indicate the decision of acceptance or rejection.

In an embodiment, the HT control field 620 may include the decision in frame 1444 of FIG. 14, frame 1544 of FIG. 15, frame 1644 of FIG. 16, and frame 1744 of FIG. 17 by second AP to participate in the multi-AP transmission. In an example, and as shown in FIG. 6, the HT control field 620 may include an A-Control subfield. The A-Control subfield may include a control list subfield including one or more control subfields. In an embodiment, the control subfield may include an indication of the decision of acceptance or rejection. In an example, the control subfield may be a BSR A-control subfield 622. In an embodiment, the BSR A-control subfield may include the indication of decision of acceptance or rejection.

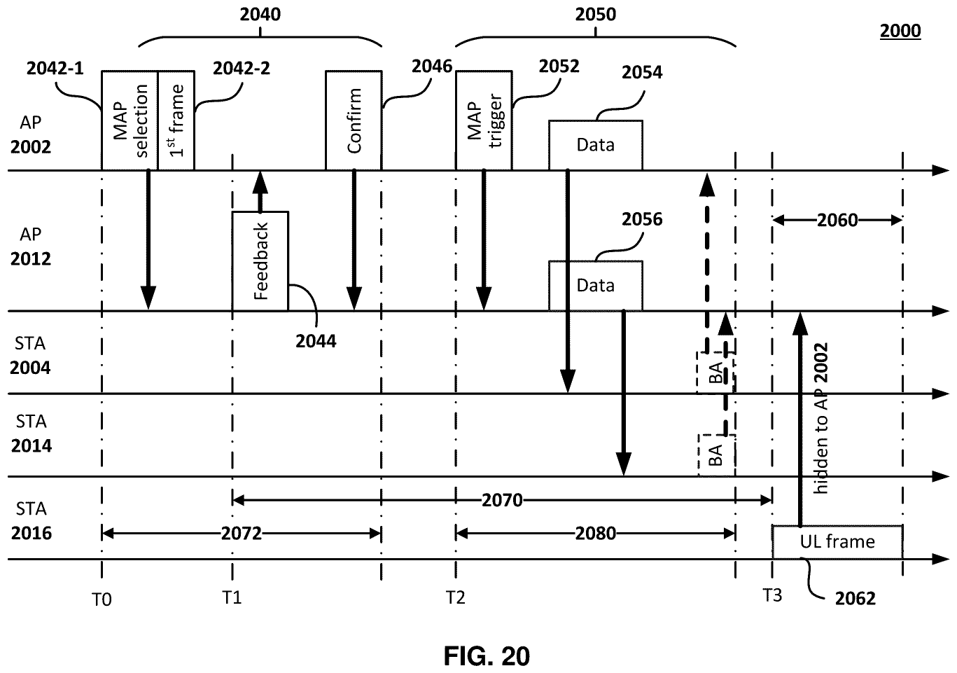

FIG. 20 illustrates an example multi-AP operation 2000 used to carry out a multi-AP transmission. Example multi-AP operation 2000 may include a first BSS and a second BSS. The first BSS may include an AP 2002 and a STA 2004. STA 2004 may be associated with AP 2002. The second BSS may include an AP 2012 and a plurality of STAs, STA 2014 and STA 2016. STA 2014 and STA 2016 may be associated with AP 2012. In an example, STA 2016 is hidden from AP 2002. In an example, AP 2002 and AP 2012 may form a multi-AP group. AP 2002 may be the master AP and AP 2012 may be a slave AP of the multi-AP group.

In describing FIG. 20, it is assumed that multi-AP setup phase 840, and multi-AP information exchange phase 842 of FIG. 8 are already completed. In example multi-AP operation 2000, a multi-AP selection phase 2040 is operated during period 2072, while a multi-AP data transmission phase 2050 is operated during period 2080 starting at time T2. In an example, period 2072 and period 2080 are separate apart to each other. As shown in FIG. 20, it is assumed that AP 2012 is unavailable for participating in multi-AP transmission during a period 2060 starting at time T3. For example, AP 2012 may be unavailable during the period 2060 because AP 2012 may schedule to receive a frame 2062 from STA 2016.

As shown in FIG. 20, example multi-AP operation 2000 may begin with multi-AP selection phase 2040. In an example, phase 2040 may include frame exchanges to allow master AP 2002 to know whether candidate slave AP 2012 may determine to participate in a multi-AP transmission based on information indicating a period 2080 for the multi-AP transmission.

As shown in FIG. 20, AP 2002 may transmit a frame 2042-1 including information regarding selection for a multi-AP transmission to AP 2012. Frame 2042-1 may be an example of frame 1042 of FIG. 10.

In an embodiment, AP 2002 may transmit a first frame 2042-2 to AP 2012. Frame 2042-2, which is an example of frame 1442 of FIG. 14, includes information indicating a period 2080 for a multi-AP transmission in phase 2050.

In an embodiment, frame 2042-1 may be transmitted including frame 2042-2. In an example, frame 2042-1 including frame 2042-2 may be a control frame used as a trigger frame. For example, frame 2042-1 may be a multi-AP trigger frame. In another example, frame 2042-1 including frame 2042-2 may be a management frame used as an action frame. For example, frame 2042-1 may be a multi-AP selection request frame.

In an embodiment, frame 2042-1 and frame 2042-2 may be transmitted in one MAC protocol data unit (MPDU). In an example, either frame 2042-1 or frame 2042-2 may be included in the header of MPDU, and the other frame 2042-2 or frame 2042-1 may be included in the body of MPDU. For example, frame 2042-1 may be a control frame used as a trigger frame included in the head of MPDU, and frame 2042-2 may be a management frame used as an action frame included in a body of MPDU. For example, frame 2042-2 may be a control frame used as a trigger frame included in the head of MPDU, and frame 2042-1 may be a management frame used as an action frame included in a body of MPDU.

In an embodiment, frame 2042-1 and frame 2042-2 may be transmitted in aggregated MPDU (A-MPDU). In an example, each MPDU may include a MAC header and a frame body. For example, frame 2042-1 may be either a control frame used as a trigger frame or a management frame used as an action frame included in a first MPDU, and frame 2042-2 may be either a control frame used as a trigger frame or a management frame used as an action frame included in a second MPDU.

In an embodiment, AP 2012 may calculate a duration of period 2070 between frame 2044 to be transmitted at time T1 to the starting time T3 of period 2060. In an embodiment, AP 2012 may compare period 2080 to period 2070 or period 2060. As shown in FIG. 20, period 2080 is included in period 2070 and is nonoverlapping with period 2060. Therefore, A P 2012 decides to accept to participate in the multi-AP transmission during period 2050.

In response to frame 2042-1 and frame 2042-2, AP 2002 may receive a frame 2044 from AP 2012. As shown in FIG. 20, frame 2044 may include the intention of AP 1812 to participate in the multi-AP transmission. Frame 2044 may include information related to buffer status and available frequency resources of AP 2012. In an embodiment, frame 2044 may further include the decision of AP 2014 to participate in multi-AP transmission in phase 2050 within period 2080. As shown in FIG. 20, the decision is an acceptance. In an example, when frame 2042-1 or first frame 2042-2 is a trigger frame, frame 2044 may be a data frame that is included in a TB PPDU in response to the trigger frame. For example, frame 2044 may be a QoS null frame or a QoS data frame. For example, the decision of AP 2014 may be included in the reserved field of a QoS control field or HT control field of a data frame. In another example, when frame 2042-1 or frame 2042-2 is an action frame, e.g., a request frame, frame 2044 may be an action frame, e.g., a response frame. For example, the decision of AP 2014 may be included in the reserved subfield of an action details field of an action frame. In an example, the action detail fields field of frame 2044 may include the decision of AP 2012 corresponding to a decision subfield 1920 of action details field 1910 of FIG. 19.

In response to receiving frame 2044, AP 2002 may confirm AP 2012 as a designated AP for the multi-AP transmission by transmitting a frame 2046 during period 2072, as shown in FIG. 20.

In an embodiment, AP 2002 transmits a third frame 2052, which is an example of frame 1452 of FIG. 14, to AP 2012 to initiate the multi-AP transmission in phase 2050 during period 2080 based on the decision included in frame 2044. As shown in FIG. 20, AP 2002 initiates phase 2050 starting at time T2 before the period 2060.

As shown in FIG. 20, phase 2050 includes AP 2002 transmitting frame 2052 at time T2, AP 2002 transmitting a frame 2054 to STA 2004, AP 2012 transmitting a frame 2056 to STA 2014. In an example, frame 2054 and frame 2056 are data frames. In an example, the phase 2050 may further include BA frames transmitted from STA 2004 to AP 2002 and from STA 2014 to AP 2012, respectively.

As shown in FIG. 20, T2 is before the period 2060 starting at time T3. As a result, AP 2012 successfully performs multi-AP transmission in phase 2050 with AP 2002 before the period 2060 for AP 2012.

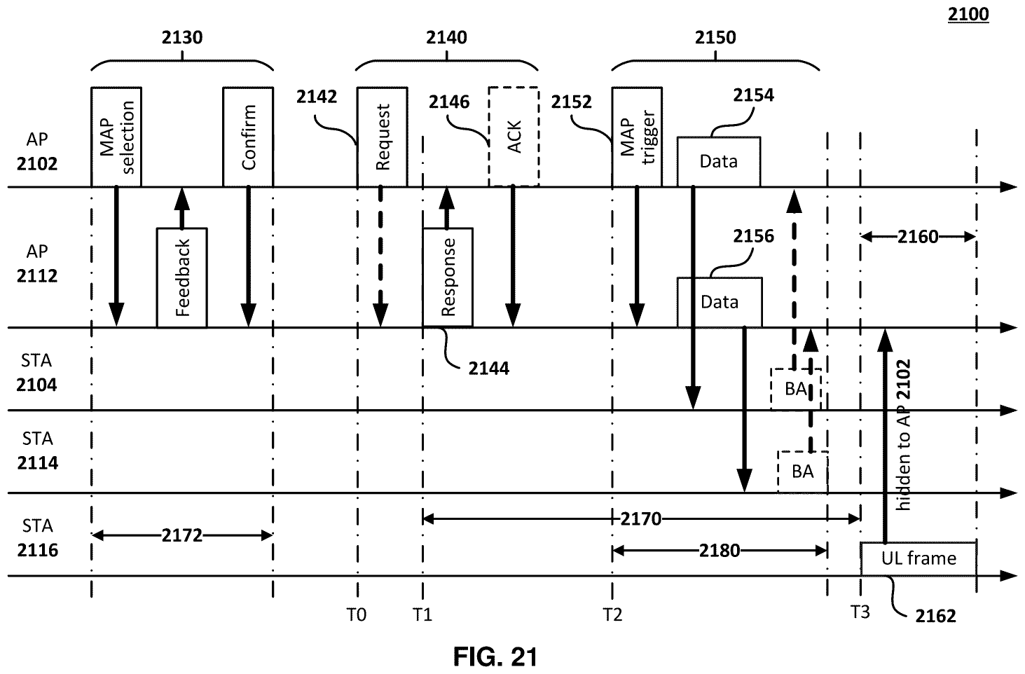

FIG. 21 illustrates an example multi-AP operation 2100 used to carry out a multi-AP transmission. Example multi-AP operation 2100 may include a first BSS and a second BSS. The first BSS may include an AP 2102 and a STA 2104. STA 2104 may be associated with AP 2102. The second BSS may include an AP 2112 and a plurality of STAs, STA 2114 and STA 2116. STA 2114 and STA 2116 may be associated with AP 2112. In an example, STA 2116 is hidden from AP 2102. In an example, AP 2102 and AP 2112 may form a multi-AP group. AP 2102 may be the master AP and AP 2112 may be a slave AP of the multi-AP group.

In describing FIG. 21, it is assumed that multi-AP setup phase 840 and multi-AP information exchange phase 842 of FIG. 8 are already completed. In example multi-AP operation 2100, a multi-AP selection phase 2130 is operated during period 2172, while a multi-AP data transmission phase 2150 is operated during period 2180 starting at time T2. In an example, period 2172 and period 2080 are separate apart to each other. As shown in FIG. 21, it is assumed that AP 2112 is unavailable for participating in multi-AP transmission during a period 2160 starting at time T3. For example, AP 2112 is unavailable during the period 2160 because AP 2112 may schedule to receive a frame 2162 from STA 2116.

As shown in FIG. 21, example multi-AP operation 2100 may begin with multi-AP selection phase 2130 using the example procedures of FIG. 10. In an example, phase 2130 may include frame exchanges to allow master AP 2102 to determine whether candidate slave AP 2112 may participate in a multi-AP transmission. As shown in FIG. 21, AP 2102 designates slave AP 2112 for a multi-AP transmission.

As shown in FIG. 21, example 2100 includes a phase 2140 after the completion of phase 2130. In an example, phase 2140 may include a frame 2142, a frame 2144, and an optional frame 2146.

In an embodiment, AP 2102 may transmit a frame 2142 to request AP 2112 to participate in a multi-AP transmission in phase 2150 at TO. Frame 2142 may be an example of first frame 1442 of FIG. 14. In an embodiment, frame 2142 includes information indicating a period 2180 for the multi-AP transmission in phase 2150. In an embodiment, frame 2142 may be a management frame used as an action frame. For example, frame 2142 may be a request frame. In an example, information of period 2180 included in frame 2142 may be included in an action field (e.g., action field 1902 of in FIG. 19).

In an embodiment, AP 2112 may calculate a duration of period 2170 between frame 2144 to be transmitted at time T1 to the starting time T3 of period 2160. In an embodiment, AP 2112 may compare period 2180 to period 2170 or period 2160. As shown in FIG. 21, period 2180 is included in period 2170 and is nonoverlapping with period 2160. Therefore, AP 2112 decides to accept to participate in the multi-AP transmission during phase 2150.

In response to frames 2142 (including frame 2142-1 and frame 2142-2), AP 2102 may receive a frame 2144 from AP 2112 at time T1. Frame 2144 may be an example of first frame 1444 of FIG. 14, In an embodiment, frame 2144 includes a decision of AP 2112 to participate in the multi-AP transmission 2150 within period 2180. As shown in FIG. 21, the decision is an acceptance. In an embodiment, frame 2144 may be a management frame used as an action frame. In an example, frame 2144 may be a response frame. In an example, information of period 2180 included in frame 2144 may be included in an action field (e.g., action field 1902 of FIG. 19).

In an embodiment, to respond to frame 2144, AP 2102 may optionally transmit a frame 2146 acknowledging the receiving of frame 2144. For example, frame 2146 may be an Ack frame.

In an embodiment, AP 2102 transmits a third frame 2152, which is an example of frame 1452 of FIG. 14, to AP 2112 to initiate the multi-AP transmission in phase 2150 during period 2180 based on the decision included in frame 2144. As shown in FIG. 21, AP 2102 initiates phase 2150 starting at time T2 before period 2160.

As shown in FIG. 21, phase 2150 includes AP 2102 transmitting frame 2152 at time T2, AP 2102 transmitting a frame 2154 to STA 2104, AP 2112 transmitting a frame 2156 to STA 2114. In an example, frame 2154 and frame 2156 are data frames. In an example, the phase 2150 may further include BA frames transmitted from STA 2104 to AP 2102 and from STA 2114 to AP 2112, respectively.

In an example, phase 2150 is an example of phase 2050 of FIG. 20. As a result, AP 2112 successfully performs multi-AP transmission in phase 2150 with AP 2102 before period 2160 for AP 2112.

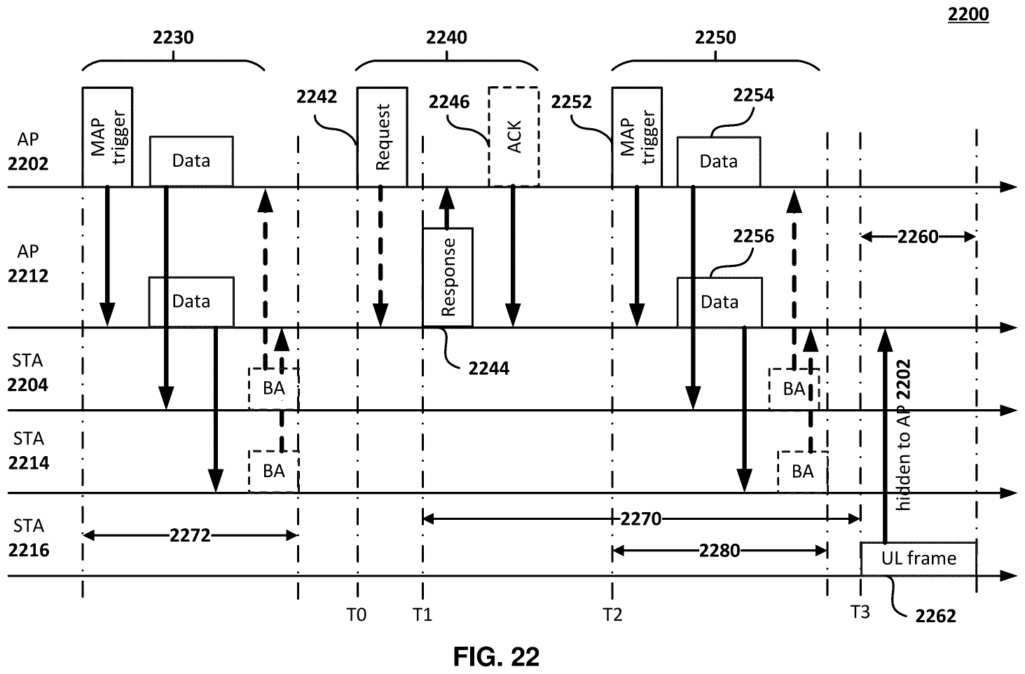

FIG. 22 illustrates an example multi-AP operation 2200 used to carry out a multi-AP transmission. Example multi-AP operation 2200 may include a first BSS and a second BSS. The first BSS may include an AP 2202 and a STA 2204. STA 2204 may be associated with AP 2202. The second BSS may include an AP 2212 and a plurality of STAs, STA 2214 and STA 2216. STA 2214 and STA 2216 may be associated with AP 2212. In an example, STA 2216 is hidden from AP 2202. In an example, AP 2202 and AP 2212 may form a multi-AP group. AP 2202 may be the master AP and AP 2212 may be a slave AP of the multi-AP group.

In describing FIG. 22, it is assumed that multi-AP setup phase 840, and multi-AP information exchange phase 842, and multi-AP selection phase 846 of FIG. 8 are already completed. In example multi-AP operation 2200, a first multi-AP data transmission phase 2230 is operated during period 2272, while a second multi-AP data transmission phase 2250 is operated during period 2280 starting at time T2. In an example, periods 2272 and 2280 are separate apart to each other. As shown in FIG. 22, it is assumed that AP 2212 is unavailable for participating in multi-AP transmission during a period 2260 starting at time T3. For example, AP 2212 is unavailable during the period 2260 because AP 2212 may schedule to receive a frame 2262 from STA 2216.

As shown in FIG. 22, example 2200 may begin with the first multi-AP data transmission phase 2230 using the example procedures of FIG. 11. As shown in FIG. 22, example multi-AP operation 2200 includes a phase 2240 after the completion of phase 2230. In an example, phase 2240 may include a frame 2242, a frame 2244, and an optional frame 2246.

In an embodiment, AP 2202 may transmit a frame 2242 to request AP 2212 to participate in a multi-AP transmission in phase 2250 at TO. Frame 2242 may be an example of first frame 1442 of FIG. 14. In an embodiment, frame 2242 includes information indicating a period 2280 for the multi-AP transmission in phase 2250. In an embodiment, frame 2242 may be a management frame used as an action frame. For example, frame 2242 may be a request frame. In an example, information of period 2180 included in frame 2242 may be included in an action field (e.g., action field 1902 of FIG. 19).

In an embodiment, AP 2212 may calculate a duration of period 2270 between frame 2244 to be transmitted at time T1 to the starting time T3 of period 2260. In an embodiment, AP 2212 may compare period 2280 to period 2270 or period 2260. As shown in FIG. 22, period 2280 is included in period 2270 and is nonoverlapping with period 2260. Therefore, AP 2212 decides to accept to participate in the multi-AP transmission during phase 2250.

In response to frames 2242, AP 2102 may receive a frame 2244 from AP 2212 at time T1. Frame 2244 may be an example of first frame 1444 of FIG. 14, In an embodiment, frame 2244 includes decision of AP 2212 to participate in the multi-AP transmission 2250 within period 2280. As shown in FIG. 22, the decision is an acceptance. In an embodiment, frame 2244 may be a management frame used as an action frame. In an example, frame 2244 may be a response frame. In an example, information of period 2280 included in frame 2244 may be included in an action field (e.g., action field 1902 of FIG. 19).

In an embodiment, to respond to frame 2244, AP 2202 may optionally transmit a frame 2246 acknowledging the receiving of frame 2244. For example, frame 2246 may be an Ack frame.

In an embodiment, AP 2202 transmits a third frame 2252, which is an example of frame 1452 of FIG. 14, to AP 2212 to initiate the multi-AP transmission in phase 2250 during period 2280 based on the decision included in frame 2244. As shown in FIG. 22, AP 2202 initiates phase 2250 starting at time T2 before period 2260.

As shown in FIG. 22, phase 2250 includes AP 2202 transmitting frame 2252 at time T2, AP 2202 transmitting a frame 2254 to STA 2204, AP 2212 transmitting a frame 2256 to STA 2214. In an example, frame 2254 and frame 2256 are data frames. In an example, the phase 2250 may further include BA frames transmitted from STA 2204 to AP 2202 and from STA 2214 to AP 2212, respectively.

In an example, phase 2250 is an example of phase 2050 of FIG. 20. As a result, AP 2212 successfully performs multi-AP transmission in phase 2250 with AP 2202 before period 2260 for AP 2212.

As would be understood by a person of skill in the art based on the teachings herein, the embodiments as described above examples may be readily extended to cases including more than two APs.

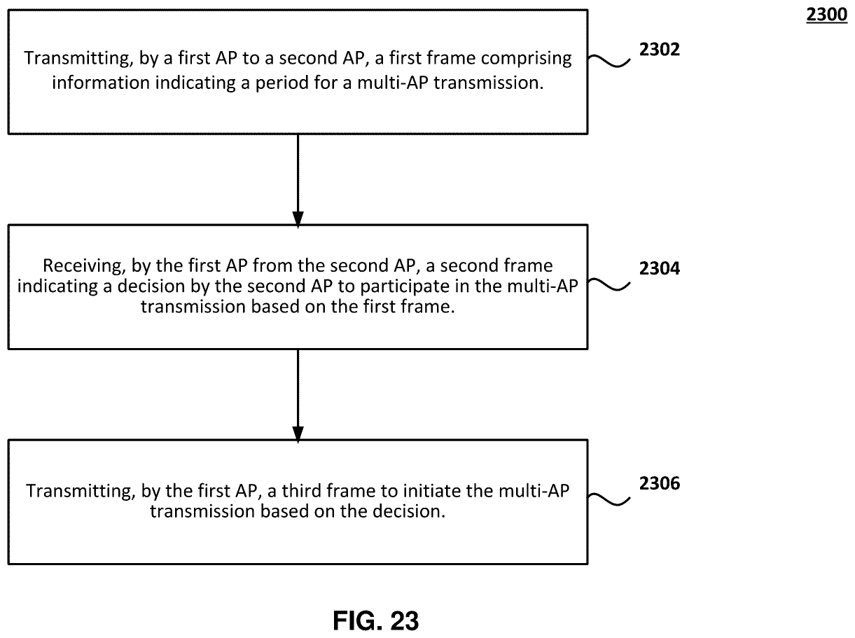

FIG. 23 illustrates an example process 2300 according to an embodiment. Example process 2300 is provided for the purpose of illustration only and is not limiting of embodiments. Process 2300 may be performed by a first AP. The first AP may be a master AP of a multi-AP group.

As shown in FIG. 23, process 2300 begins in step 2302, which includes transmitting, by a first AP to a second AP, a first frame comprising information indicating a period for a multi-AP transmission.

In an embodiment, the first AP and the second AP belong to different BSSs. In an embodiment, the information further indicates a starting time and a duration of the period for the multi-AP transmission. In an embodiment, the period for the multi-AP transmission comprises a plurality of periods for multi-AP transmissions. In an embodiment, the information further indicates a periodicity for the plurality of periods for multi-AP transmissions. In an embodiment, the information further indicates one or more offsets between the plurality of periods for multi-AP transmissions comprising the period for the multi-AP transmission.

In an embodiment, the first frame comprises a control frame. In an embodiment, the control frame comprises a trigger frame for soliciting the second AP to participate in the multi-AP transmission within the period for the multi-AP transmission. In an embodiment, the trigger frame comprises a user info list field comprising the information indicating the period for the multi-AP transmission. In an embodiment, the trigger frame comprises a common info field comprising the information indicating the period for the multi-AP transmission.

In an embodiment, the first frame comprises a management frame. In an embodiment, the management frame comprises an action frame comprising a request frame requesting the second AP to participate in the multi-AP transmission within the period for the multi-AP transmission. In an embodiment, the action frame further comprises an action field comprising the information indicating the period for the multi-AP transmission.

As shown in FIG. 23, in step 2304, process 2300 includes receiving, by the first AP from the second AP, a second frame indicating a decision by the second AP to participate in the multi-AP transmission based on the first frame.

In an embodiment, the second frame comprises a data frame. In an embodiment, the data frame comprises a feedback frame to the first frame. In an embodiment, the data frame comprises a HT control field indicating the second AP accepts to participate in the multi-AP transmission within the period based on the receiving of the first frame.

In an embodiment, the second frame comprises a management frame. In an embodiment, the management frame comprises an action frame comprising an action field indicating the second AP accepts to participate in the multi-AP transmission within the period based on the receiving of the first frame.

In an embodiment, the first AP transmits an acknowledgment to acknowledge reception of the second frame.

As shown in FIG. 23, in step 2306, process 2300 includes transmitting, by the first AP, a third frame to initiate the multi-AP transmission based on the decision.

In an embodiment, the third frame comprises a control frame or a management frame.

In an embodiment, process 2300 may further comprise: transmitting, by the first AP to the second AP, a first indication of support by the first AP of a period coordination capability; and receiving, by the first AP from the second AP, a second indication of support by the second AP of the period coordination capability. In an embodiment, the period coordination capability allows the first AP to transmit the first frame and the third frame. In an embodiment, the period coordination capability allows the first AP to receive the second frame. In an embodiment, the period coordination capability allows the second AP to receive the first frame and the third frame. In an embodiment, the period coordination capability allows the second AP to transmit the second frame.

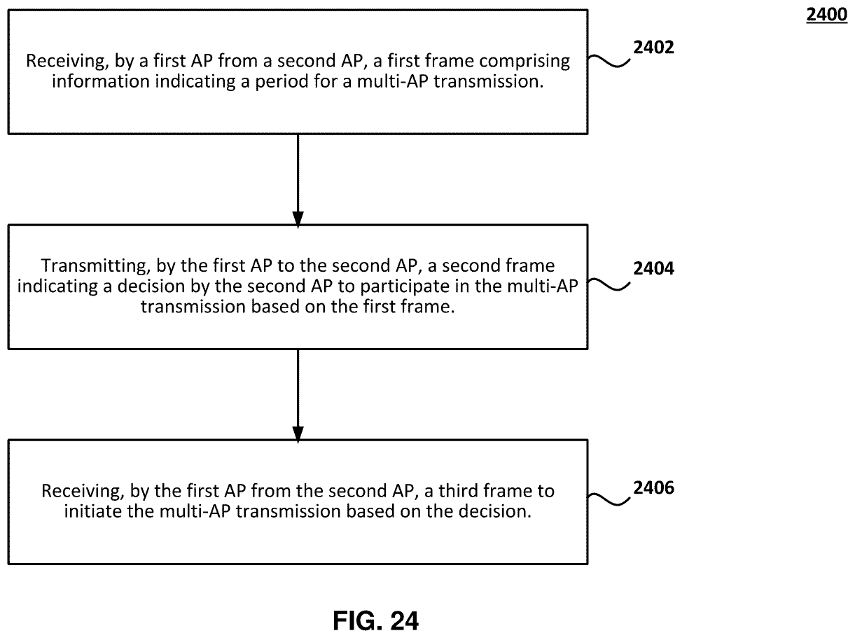

FIG. 24 illustrates an example process 2400 according to an embodiment. Example process 2400 is provided for the purpose of illustration only and is not limiting of embodiments. Process 2400 may be performed by a first AP. The first AP may be a slave AP of a multi-AP group.

As shown in FIG. 24, process 2400 begins in step 2402, which includes receiving, by a first AP from a second AP, a first frame comprising information indicating a period for a multi-AP transmission.

In an embodiment, the first AP and the second AP belong to different BSSs. In an embodiment, the information further indicates a starting time and a duration of the period for the multi-AP transmission. In an embodiment, the period for the multi-AP transmission comprises a plurality of periods for multi-AP transmissions. In an embodiment, the information further indicates a periodicity for the plurality of periods for multi-AP transmissions. In an embodiment, the information further indicates one or more offsets between the plurality of periods for multi-AP transmissions comprising the period for the multi-AP transmission.

In an embodiment, the first frame comprises a control frame. In an embodiment, the control frame comprises a trigger frame for soliciting the first AP to participate in the multi-AP transmission within the period for the multi-AP transmission. In an embodiment, the trigger frame comprises a user info list field comprising the information indicating the period for the multi-AP transmission. In an embodiment, the trigger frame comprises a common info field comprising the information indicating the period for the multi-AP transmission.

In an embodiment, the first frame comprises a management frame. In an embodiment, the management frame comprises an action frame comprising a request frame requesting the first AP to participate in the multi-AP transmission within the period for the multi-AP transmission. In an embodiment, the action frame further comprises an action field comprising the information indicating the period for the multi-AP transmission.

As shown in FIG. 24, in step 2404, process 2400 includes transmitting, by the first AP to the second AP, a second frame indicating a decision by the second AP to participate in the multi-AP transmission based on the first frame.

In an embodiment, the second frame comprises a data frame. In an embodiment, the data frame comprises a feedback frame to the first frame. In an embodiment, the data frame comprises a HT control field indicating the first AP accepts to participate in the multi-AP transmission within the period based on the receiving of the first frame.

In an embodiment, the second frame comprises a management frame. In an embodiment, the management frame comprises an action frame comprising an action field indicating the first AP accepts to participate in the multi-AP transmission within the period based on the receiving of the first frame.

In an embodiment, the first AP transmits an acknowledgment to acknowledge reception of the second frame.

As shown in FIG. 24, in step 2406, process 2400 includes receiving, by the first AP from the second AP, a third frame to initiate the multi-AP transmission based on the decision.

In an embodiment, the third frame comprises a control frame or a management frame.

In an embodiment, process 2400 may further comprise: receiving, by the first AP from the second AP, a first indication of support by the second AP of a period coordination capability; and transmitting, by the first AP to the second AP, a second indication of support by the first AP of the period coordination capability. In an embodiment, the period coordination capability allows the first AP to receive the first frame and the third frame. In an embodiment, the period coordination capability allows the first AP to transmit the second frame. In an embodiment, the period coordination capability allows the second AP to transmit the first frame and the third frame. In an embodiment, the period coordination capability allows the second AP to receive the second frame.

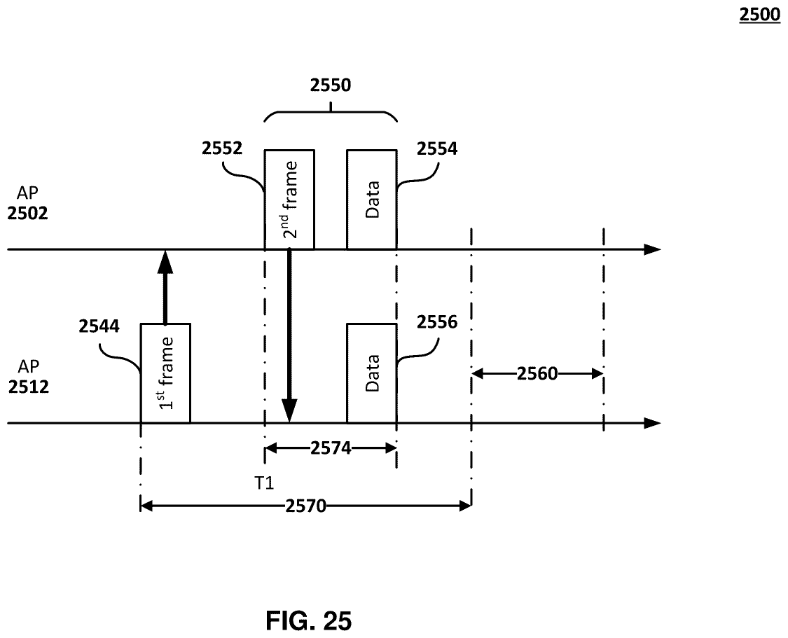

FIG. 25 illustrates an example multi-AP operation 2500 of frame exchanges including information indicating a period of unavailability for a second AP to participate in a multi-AP transmission. Example multi-AP operation 2500 is provided for the purpose of illustration only and is not limiting. Example multi-AP operation 2500 includes a plurality of APs, AP 2502, and AP 2512. In an example, AP 2502 and AP 2512 form a multi-AP group. AP 2502 may be the master AP while AP 2512 may be a slave AP of the multi-AP group. For example, AP 2502 may obtain a TXOP making it the master AP of the multi-AP group. Alternatively, AP 2502 may be designated as the master AP by a multi-AP controller. AP 2502 and AP 2512 may exchange frames to set up a multi-AP transmission.

In an example, each of AP 2502 and AP 2512 may have one or more associated STAs (not shown in FIG. 25). For the purpose of illustration, it is assumed that AP 2502 and AP 2512 may exchange a plurality of frames, for example, a first frame 2544, and a second frame 2552, during a multi-AP operation procedure. It is further assumed, for the purpose of illustration, that the order of frames shown in FIG. 25 may or may not relate to the order of the frames being transmitted by AP 2502 and AP 2512. It is also assumed that AP 2512 is unavailable for participating in multi-AP transmission during a period of unavailability 2560 starting at time T2.

In an embodiment, AP 2502 receives first frame 2544 from AP 2512 at time T0. In an example, AP 2512 may be a candidate slave AP that intends to participate in a multi-AP transmission. In an example, AP 2512 may be a designated slave AP that is selected to participate in a multi-AP transmission. Frame 2544 comprises information indicating period of unavailability 2560 for the AP 2512 to participate in a multi-AP transmission. In an embodiment, the information included in frame 2544 may further indicate a starting time T2 and a duration of the period of unavailability 2560. Frame 2544 may be a data frame or a management frame.

In an embodiment, AP 2502 may calculate duration of a period 2570 between receiving frame 2544 at time T0 to the starting time T2 of period of unavailability 2560. In an embodiment, AP 2502 may compare the duration of period 2570 and a duration of a period 2574 used to perform the multi-AP transmission in phase 2550. As shown in FIG. 25, the duration of period 2570 is larger than the duration of period 2574. In an embodiment, AP 2502 schedules AP 2512 to perform the multi-AP transmission before period of unavailability 2560 based on receiving the information indicating period of unavailability 2560 included in frame 2544.

In an embodiment, AP 2502 transmits second frame 2552 based on the first frame 2544, to initiate the multi-AP transmission in phase 2550 before the period of unavailability 2560. In an embodiment, phase 2550 includes AP 2502 transmitting second frame 2552 at time T1, AP 2502 transmitting a frame 2554, and AP 2512 transmitting a frame 2556. As shown in FIG. 25, T1 is before the period of unavailability 2560 starting at time T2. As a result, AP 2512 successfully performs multi-AP transmission in phase 2550 with AP 2502 before the period of unavailability 2560 of AP 2512. Frame 2552 may be a management frame or a control frame.

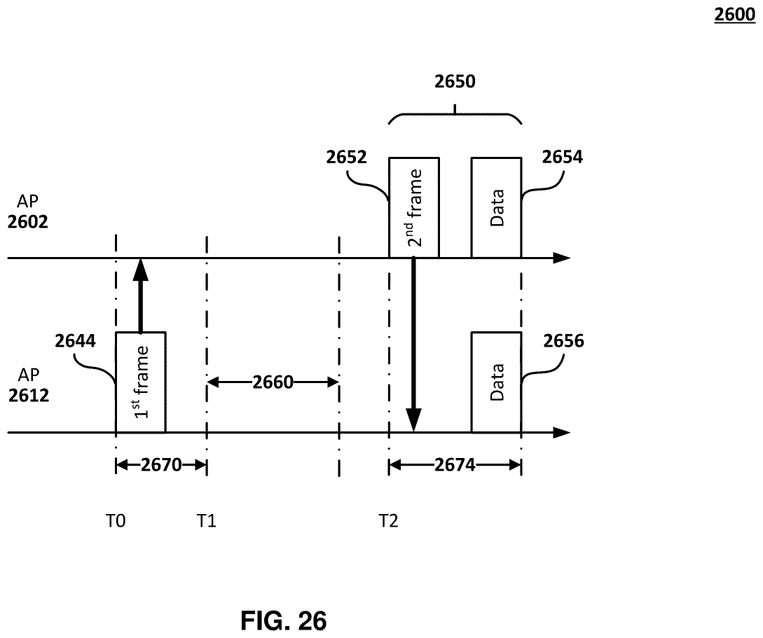

FIG. 26 illustrates an example multi-AP operation 2600 of frame exchanges including information indicating a period of unavailability for a second AP to participate in a multi-AP transmission. Example multi-AP operation 2600 is provided for the purpose of illustration only and is not limiting. Example multi-AP operation 2600 includes a plurality of APs, AP 2602, and AP 2612. In an example, APs 2602 and 2612 form a multi-AP group. AP 2602 may be the master AP while AP 2612 may be a slave AP of the multi-AP group. For example, AP 2602 may obtain a TXOP making it the master AP of the multi-AP group. Alternatively, AP 2602 may be designated as the master AP by a multi-AP controller. AP 2602 and AP 2612 may exchange frames to set up a multi-AP transmission.

In an example, each of AP 2602 and AP 2612 may have one or more associated STAs (not shown in FIG. 26). For the purpose of illustration, it is assumed that AP 2602 and AP 2612 may exchange a plurality of frames, for example, a first frame 2644, and a second frame 2652, during a multi-AP operation procedure. It is further assumed, for the purpose of illustration, that the order of frames shown in FIG. 26 may or may not relate to the order of the frames being transmitted by AP 2602 and AP 2612. It is also assumed that AP 2612 is unavailable for participating in multi-AP transmission during a period of unavailability 2660 starting at time T1.

In an embodiment, AP 2602 receives first frame 2644 from AP 2612 at time T0. In an example, AP 2612 may be a candidate slave AP that intends to participate in a multi-AP transmission. In an example, AP 2612 may be a designated slave AP that is selected to participate in a multi-AP transmission. Frame 2644 comprises information indicating the period of unavailability 2660 for the AP 2612 to participate in a multi-AP transmission. In an embodiment, the information included in frame 2644 may further indicate a starting time T1 and a duration of the period of unavailability 2660. Frame 2644 may be a data frame or a management frame.

In an embodiment, AP 2602 may calculate duration of a period 2670 between receiving frame 2644 at time T0 to the starting time T1 of period of unavailability 2660. In an embodiment, AP 2602 may compare the duration of period 2670 and a duration of a period 2674 used to perform the multi-AP transmission in phase 2650. As shown in FIG. 26, the duration of period 2670 is smaller than the duration of period 2674. In an embodiment, AP 2602 schedules the AP 2612 to perform the multi-AP transmission after period of unavailability 2660 based on receiving the information indicating period of unavailability 2660 included in frame 2644.

In an embodiment, AP 2602 transmits second frame 2652 based on the first frame 2644, to initiate the multi-AP transmission in phase 2650 after the period of unavailability 2660. In an embodiment, phase 2650 includes AP 2602 transmitting second frame 2652 at time T2, AP 2602 transmitting a frame 2654, and AP 2612 transmitting a frame 2656. In an example, T2 is after the period of unavailability 2660 starting at time T1. As a result, AP 2612 successfully performs multi-AP transmission in phase 2650 with AP 2602 after the period of unavailability 2660 of AP 2612. Frame 2652 may be a management frame or a control frame.

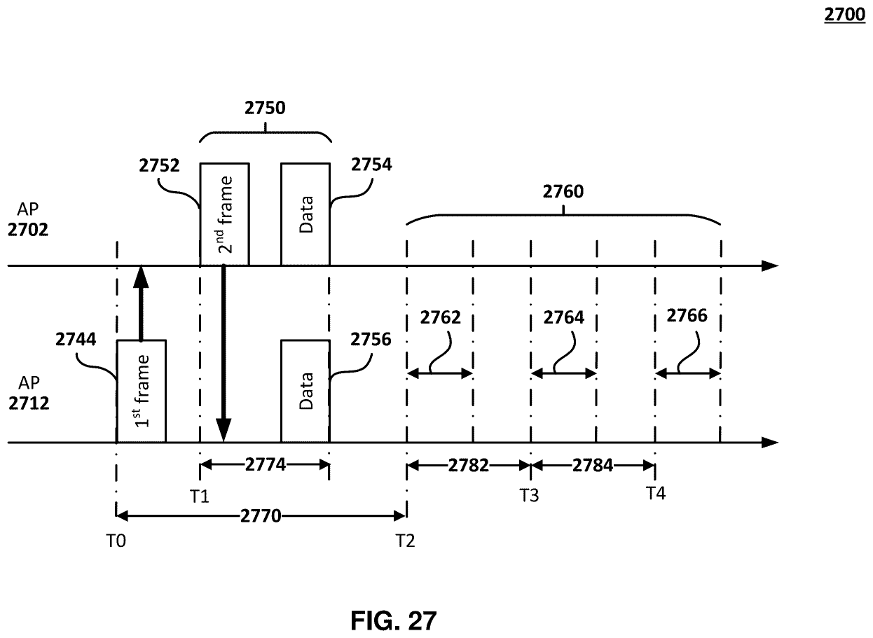

FIG. 27 illustrates an example multi-AP operation 2700 of frame exchanges including information indicating a period of unavailability for a second AP to participate in a multi-AP transmission. Example multi-AP operation 2700 is provided for the purpose of illustration only and is not limiting. Example multi-AP operation 2700 includes a plurality of APs, AP 2702, and AP 2712. In an example, APs 2702 and 2712 form a multi-AP group. AP 2702 may be the master AP while AP 2712 may be a slave AP of the multi-AP group. For example, AP 2702 may obtain a TXOP making it the master AP of the multi-AP group. Alternatively, AP 2702 may be designated as the master AP by a multi-AP controller. AP 2702 and AP 2712 may exchange frames to set up a multi-AP transmission.

In an example, each of AP 2702 and AP 2712 may have one or more associated STAs (not shown in FIG. 27). For the purpose of illustration, it is assumed that AP 2702 and AP 2712 may exchange a plurality of frames, for example, a first frame 2744, and a second frame 2752, during a multi-AP operation procedure. It is further assumed, for the purpose of illustration, that the order of frames shown in FIG. 27 may or may not relate to the order of the frames being transmitted by AP 2702 and AP 2712.

In an embodiment, the period of unavailability for the second AP to participate in multi-AP transmission may include a plurality of periods of unavailability. As shown in FIG. 27, it is assumed that AP 2712 is unavailable for participating in multi-AP transmission during a plurality of periods of unavailability 2760. In example multi-AP operation 2700, a plurality of periods of unavailability 2760 may include a period of unavailability 2762 starting at time T2, a period of unavailability 2764 starting at time T3, and a period of unavailability 2766 starting at time T4. In an example, period of unavailability 2764 starts at time T3 after an offset 2782 in reference to period of unavailability 2762 starting at time T2. In an example, period of unavailability 2766 starts at T4 after an offset 2784 in reference to period of unavailability 2764 starting at time T3. In an example, the plurality of periods of unavailability 2760 may be periodic, wherein offset 2782 and offset 2784 use the same value. In an implementation, the durations of period of unavailability 2762, period of unavailability 2764, and period of unavailability 2766 may use the same value. In an example, the plurality of periods of unavailability 2760 may be without periodicity. In an implementation, offset 2782 and offset 2784 may use the same value or different values. In an implementation, the durations of period of unavailability 2762, period of unavailability 2764, and period of unavailability 2766 may use the same value or different values.

In an embodiment, AP 2702 receives first frame 2744 from AP 2712 at time T0. In an example, AP 2712 may be a candidate slave AP that intends to participate in a multi-AP transmission. In an example, AP 2712 may be a designated slave AP that is selected to participate in a multi-AP transmission. Frame 2744 comprises information indicating the plurality of periods of unavailability 2760 for the AP 2712 to participate in a multi-AP transmission. In an embodiment, the information included in frame 2744 may further indicate starting time T2, a duration of the period of unavailability 2762. In an embodiment, the information included in frame 2744 may further indicate a value of offset 2782 for a periodicity for a plurality of periods of unavailability 2760. In an embodiment, the information further indicates one offset value between the plurality of periods of unavailability 2760. For example, the values of offset 2782 and offset 2784 are the same. In an embodiment, the information further indicates two or more offset values between the plurality of periods of unavailability 2760. For example, the values of offset 2782 and offset 2784 are different. In an embodiment, the information further indicates two or more durations of periods of unavailability, e.g., period of unavailability 2762, period of unavailability 2764, and period of unavailability 2766. For example, durations of period of unavailability 2762, period of unavailability 2764, and period of unavailability 2766 are different. In an embodiment, the information further indicates a number of periods included in the plurality of periods of unavailability 2760. Frame 2744 may be a data frame or a management frame.

In an embodiment, AP 2702 may calculate a duration of a period 2770 between receiving frame 2744 at time T0 to the starting time T2 of a plurality of periods of unavailability 2760. In an embodiment, AP 2702 may compare the duration of period 2770 and a duration of a period 2774 used to perform the multi-AP transmission in phase 2750. As shown in FIG. 27, the duration of period 2770 is larger than the duration of period 2774. In an embodiment, AP 2702 schedules the AP 2712 to perform the multi-AP transmission before the plurality of periods of unavailability 2760 based on receiving the information indicating the plurality of periods of unavailability 2760 included in frame 2744.

In an embodiment, AP 2702 transmits second frame 2752 based on the first frame 2744, to initiate the multi-AP transmission in phase 2750 before the plurality of periods of unavailability 2760. In an embodiment, phase 2750 includes AP 2702 transmitting second frame 2752 at time T1, AP 2702 transmitting a frame 2754, and AP 2712 transmitting a frame 2756. In an example, T1 is before the plurality of periods of unavailability 2760 starting at time T2. As a result, AP 2712 successfully performs multi-AP transmission in phase 2750 with AP 2702 before the plurality of periods of unavailability 2760 of AP 2712. Frame 2752 may be a control frame or a management frame.

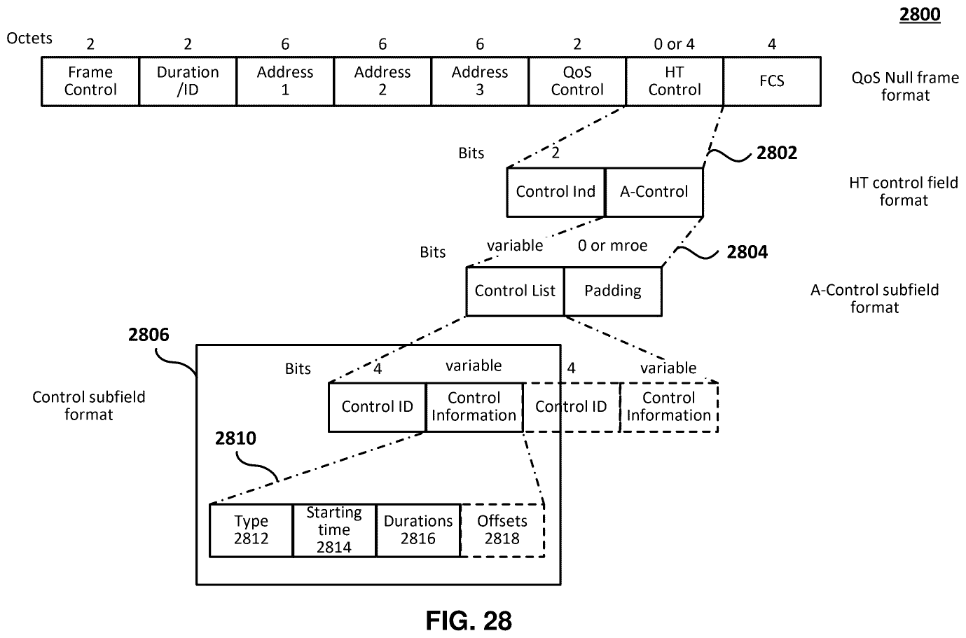

As mentioned above, first frame 2544 of FIG. 25, first frame 2644 of FIG. 26, and first frame 2744 of FIG. 27 may include data frames or management frames. FIG. 28 and FIG. 17 illustrate examples of a data frame and a management frame, respectively. In an embodiment, the data frame includes feedback to a trigger frame. For example, the first frame used as a data frame may be efficient for a plurality of APs simultaneously transmitting their first frames as feedback to the trigger frame transmitted by a master AP. In an embodiment, the management frame includes an action frame. For example, the first frame used as an action frame may be flexible for an AP intent to transmit its first frame to the master AP.

FIG. 28 illustrates an example data frame 2800 including information indicating a period of unavailability for a second AP to participate in a multi-AP transmission. As shown in FIG. 28, data frame 2800 may include an HT control field 2802.

In an embodiment, the HT control field 2802 may include the information indicating a period of unavailability for a second AP to participate in a multi-AP transmission. As shown in FIG. 28, the HT control field 2802 may include an A-Control subfield 2804. The A-Control subfield 2804 may include a control list subfield including a control subfield 2806.

In an embodiment, the control subfield 2806 may include information indicating the period of unavailability for a second AP to participate in a multi-AP transmission. In an example, the control subfield 2806 may include a subfield 2812 for a type of the period of unavailability, a subfield 2814 for a starting time of the period of unavailability, and a subfield 2816 for a duration of the period of unavailability, for a second AP to participate in a multi-AP transmission.

In an embodiment, the control subfield 2806 may further include information indicating a plurality of periods of unavailability for a second AP to participate in a multi-AP transmission. In an example, the control subfield 2806 may include a subfield 2812 for a type of a plurality of periods of unavailability, a subfield 2814 for a starting time of a plurality of periods of unavailability, a subfield 2816 for one or more durations of periods of unavailability, and an optional subfield 2818 for one or more offsets between the plurality of periods of unavailability, for a second AP to participate in a multi-AP transmission.

In an implementation, subfield 2812 may be set to 0 to indicate a period of unavailability, or may be set to 1 to indicate a plurality of periods of unavailability with a periodicity, or may be set to a number larger than 1 to indicate a plurality of periods of unavailability without periodicity. In an example, subfield 2814 may be a timeout value in milliseconds for the starting time. In an example, subfield 2816 may be a time duration value in milliseconds. In an implementation, subfield 2816 may be one value when the durations of the plurality of periods of unavailability are the same. In an implementation, subfield 2816 may be multiple values when the durations of the plurality of periods of unavailability are different. In an example, subfield 2818 may be an offset value in milliseconds. In an implementation, subfield 2818 may be one value when the offsets of the plurality of periods of unavailability are the same. In an implementation, subfield 2818 may be multiple values when the offsets of the plurality of periods of unavailability are different.

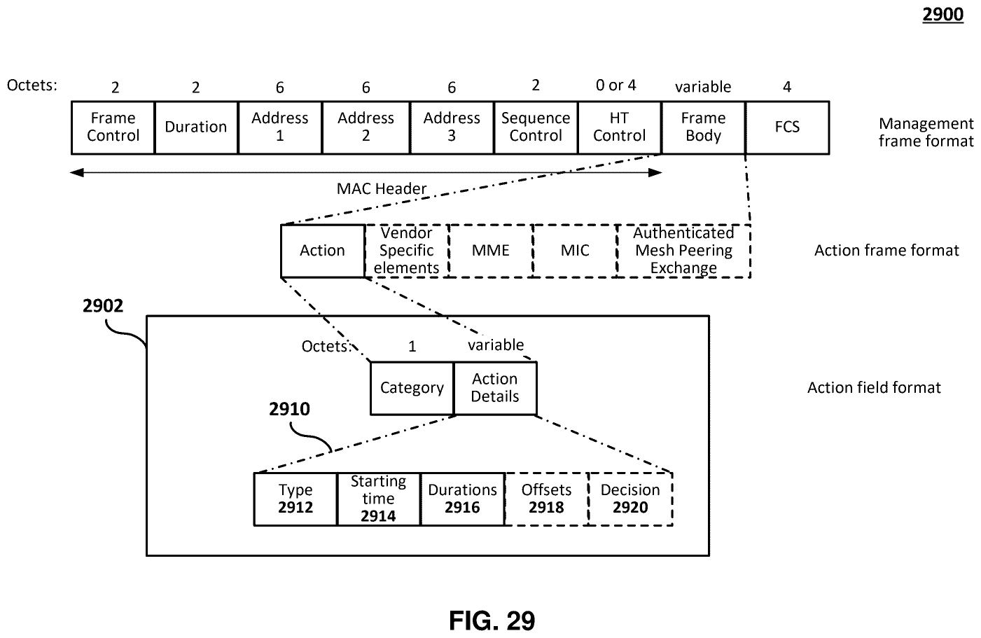

FIG. 29 illustrates an example action frame 2900 including information indicating a period of unavailability for a second AP to participate in a multi-AP transmission.

As shown in FIG. 29, action frame 2900 may include an action field 2902. In an embodiment, the action field 2902 may include information indicating a period of unavailability for a second AP to participate in a multi-AP transmission. The action field 2902 may include an action details field 2910.

In an embodiment, the action details field 2910 may include information indicating a period of unavailability for a second AP to participate in a multi-AP transmission. In an example, the action details field 2910 may include a subfield 2912 for a type of the period of unavailability, a subfield 2914 for a starting time of the period of unavailability, a subfield 2916 for a duration of the period of unavailability, and an optional subfield 2920 for the decision of a first AP to accept or reject, for a second AP to participate in a multi-AP transmission.

In an embodiment, the action details field 2910 may further include information indicating a plurality of periods of unavailability for a second AP to participate in a multi-AP transmission. In an example, the action details field 2910 may include a subfield 2912 for a type of a plurality of periods of unavailability, a subfield 2914 for a starting time of a plurality of periods of unavailability, a subfield 2916 for one or more durations of periods of unavailability, an optional subfield 2918 for one or more offsets between the plurality of periods of unavailability, an optional subfield 2920 for the decision of a first AP to accept or reject, for a second AP to participate in a multi-AP transmission.

In an implementation, subfield 2912 may be set to 0 to indicate a period of unavailability, or may be set to 1 to indicate a plurality of periods of unavailability with a periodicity, or may be set to a number larger than 1 to indicate a plurality of periods of unavailability without periodicity. In an example, subfield 2914 may be a timeout value in milliseconds for the starting time. In an example, subfield 2916 may be a time duration value in milliseconds. In an implementation, subfield 2916 may be one value when the durations of the plurality of periods of unavailability are the same. In an implementation, subfield 2916 may be multiple values when the durations of the plurality of periods of unavailability are different. In an example, subfield 2918 may be an offset value in milliseconds. In an implementation, subfield 2918 may be one value when the offsets of the plurality of periods of unavailability are the same. In an implementation, subfield 2918 may be multiple values when the offsets of the plurality of periods of unavailability are different.

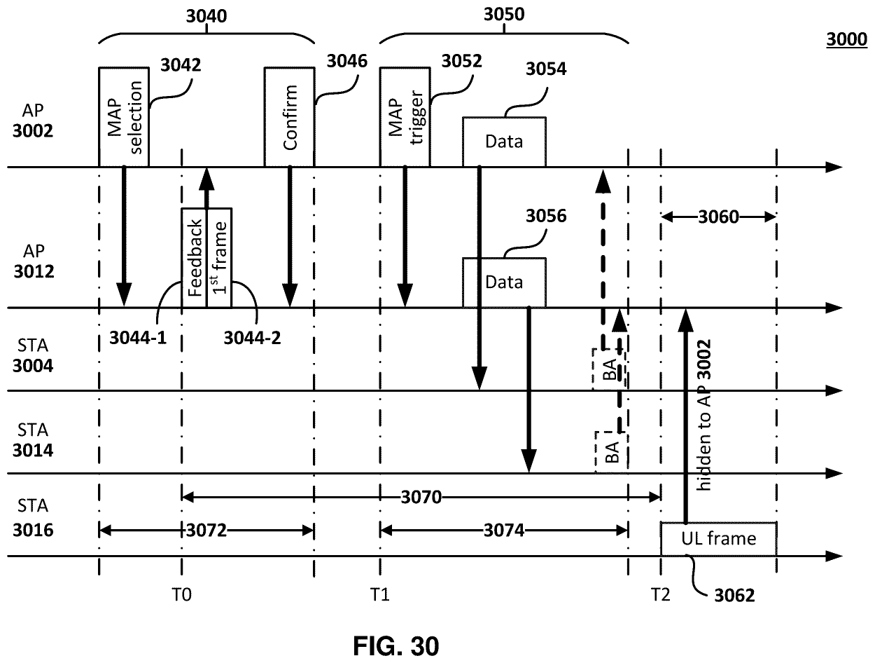

FIG. 30 illustrates an example multi-AP operation 3000 which may be used to carry out a multi-AP transmission according to an embodiment. Example multi-AP operation 3000 may include a first BSS and a second BSS. The first BSS may include an AP 3002 and a STA 3004. STA 3004 may be associated with AP 3002. The second BSS may include an AP 3012 and a plurality of STAs, STA 3014 and STA 3016. STA 3014 and STA 3016 may be associated with AP 3012. It is assumed that STA 3016 is hidden from AP 3002. In an example, AP 3002 and AP 3012 may form a multi-AP group. AP 3002 may be the master AP and AP 3012 may be a slave AP of the multi-AP group.

In an example, as shown in FIG. 30, it is assumed that multi-AP setup phase 840, and multi-AP information exchange phase 842 of FIG. 8 are already completed. In example multi-AP operation 3000, a multi-AP selection phase 3040 is operated during period 3072, while a multi-AP data transmission phase 3050 is operated during period 3074 starting at time T1. In an example, period 3072 and period 3074 are separate apart to each other. As shown in FIG. 30, it is assumed that AP 3012 is unavailable for participating in multi-AP transmission during a period of unavailability 3060 starting at time T2. For example, the reason AP 3012 being unavailable during the period of unavailability 3060 may be that AP 3012 may schedule to receive a frame 3062 from STA 3016.

As shown in FIG. 30, example multi-AP operation 3000 may begin with multi-AP selection phase 3040. In an example, phase 3040 may include frame exchanges to allow master AP 3002 to determine whether candidate slave AP 3012 may participate in a multi-AP transmission based on information indicating a period of unavailability 3060 for AP 3012 to participate in a multi-AP transmission.

As shown in FIG. 30, AP 3002 may transmit a frame 3042 including information regarding selection for a multi-AP transmission to AP 3012. Frame 3042 may be similar to frame 1042 of FIG. 10. In an example, frame 1042 may be a control frame, e.g., a trigger frame. In another example, frame 1042 may be a management frame, e.g., action frame.

In response to frame 3042, AP 3002 may receive a frame 3044-1 from AP 3012. As shown in FIG. 30, frame 3044-1 may include the intention of AP 3012 to participate in the multi-AP transmission. In an example, frame 3044-1 may include information related to buffer status and available frequency resources of AP 3012. In an example, when frame 3042 is a trigger frame, e.g., a multi-AP trigger frame, frame 3044-1 may be a data frame that is included in a TB PPDU in response to the trigger frame. In another example, when frame 3042 is an action frame, e.g., a multi-AP selection request frame, frame 3044-1 may be a multi-AP selection response frame.

In an embodiment, AP 3002 receives a first frame 3044-2 from AP 3012. Frame 3044-2 which is an example of frame 2544 of FIG. 25 includes information indicating a period of unavailability 3060 for AP 3012 to participate in a multi-AP transmission.

In an embodiment, frame 3044-2 may be a data frame that is included in a TB PPDU. In an embodiment, frame 3044-2 may include the information indicating the period of unavailability 3060 in an HT control field of the data frame. For example, the HT control field of frame 3044-2 may include a control information subfield corresponding to control information subfield 2810 of FIG. 28.

In an example, frame 3044-2 may be a QoS null frame. As described above with reference to FIG. 6, a QoS null frame refers to a QoS data frame with an empty frame body. For example, a QoS null frame may include, among other fields, a QoS control field and an HT control field. In another example, frame 3044-2 may be a QoS data frame, which includes similar fields as a QoS null frame. In an example, where frame 3044-2 may be a QoS null frame or a QoS data frame, information indicating a period of unavailability 3060 may be provided in the HT control field of the QoS null frame or the QoS data frame. For example, the HT control field of frame 3044-2 may include a control information subfield corresponding to control information subfield 2810 of FIG. 28.

In an embodiment, frame 3044-2 may be a management frame used as an action frame including a request or response frame including the information indicating a period of unavailability 3060 corresponding to action details field 2910 of FIG. 29.

In an embodiment, frame 3044-1 and frame 3044-2 are the same frame included in the TB PPDU. In an embodiment, frame 3044-1 and frame 3044-2 are different frames aggregated in the TB PPDU.

As discussed in example multi-AP operation 2500 of FIG. 25, AP 3002 may calculate a duration of a period 3070 between receiving frame 3044-1 at time T0 to the starting time T2 of period of unavailability 3060. In an embodiment, AP 3002 may compare the duration of period 3070 and a duration of a period 3074 used to perform the multi-AP transmission in phase 3050. As shown in FIG. 30, the duration of period 3070 is larger than the duration of period 3074. In an embodiment, AP 3002 schedules AP 3012 to perform the multi-AP transmission in phase 3050 before period of unavailability 3060 based on receiving the information indicating period of unavailability 3060 included in frame 3044-2.

Based on receiving frames 3044-1 and 3044-2, AP 3002 may confirm AP 3012 as a designated AP for the multi-AP transmission by transmitting a frame 3046 during period 3072 as shown in FIG. 30.

In an embodiment, AP 3002 transmits a frame 3052, which is an example of frame 2552 of FIG. 25, to AP 3012 to initiate the multi-AP transmission in phase 3050 during period 3074 based on the scheduling. As shown in FIG. 30, AP 3002 initiates phase 3050 starting at time T1 before the period of unavailability 3060.

As shown in FIG. 30, phase 3050 includes AP 3002 transmitting second frame 3052 at time T1, AP 3002 transmitting a frame 3054 to STA 3004, AP 3012 transmitting a frame 3056 to STA 3014. In an example, frame 3054 and frame 3056 are data frames. In an example, the phase 3050 may further include BA frames transmitted from STA 3004 to AP 3002 and from STA 3014 to AP 3012, respectively.

As shown in FIG. 30, T1 is before the period of unavailability 3060 starting at time T2. As a result, AP 3012 successfully performs multi-AP transmission in phase 3050 with AP 3002 before the period of unavailability 3060 for AP 3012.

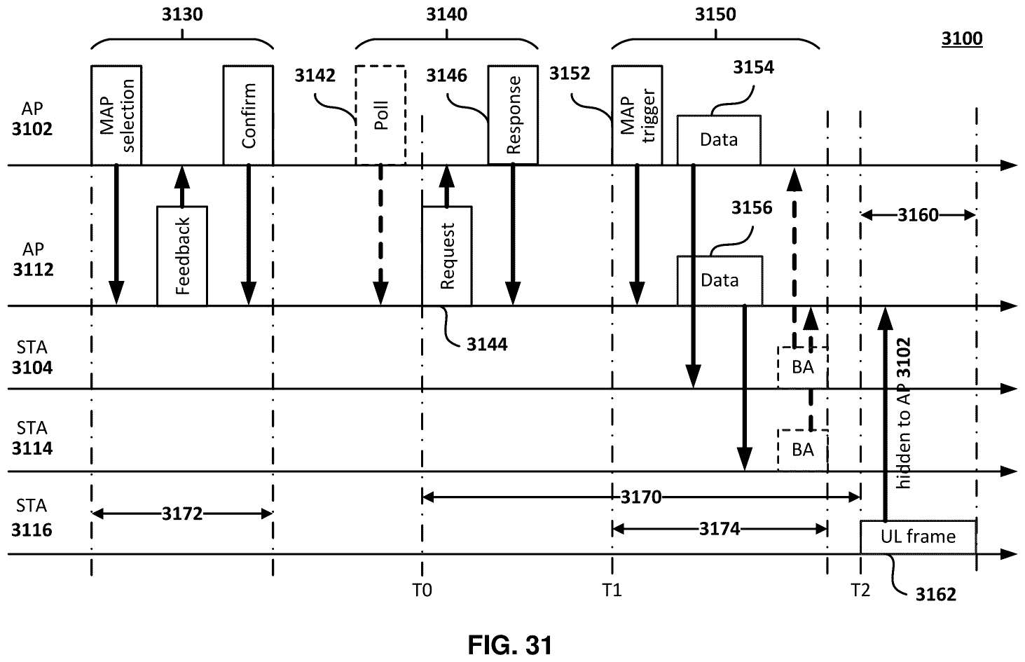

FIG. 31 illustrates an example multi-AP operation 3100 that may be used to carry out a multi-AP transmission according to an embodiment. Example multi-AP operation 3100 may include a first BSS and a second BSS. The first BSS may include an AP 3102 and a STA 3104. STA 3104 may be associated with AP 3102. The second BSS may include an AP 3112 and a plurality of STAs, STA 3114 and STA 3116. STA 3114 and STA 3116 may be associated with AP 3112. It is assumed that STA 3116 is hidden from AP 3102. In an example, AP 3102 and AP 3112 may form a multi-AP group. AP 3102 may be the master AP and AP 3112 may be a slave AP of the multi-AP group.

In an example, as shown in FIG. 31, it is assumed that multi-AP setup phase 840, and multi-AP information exchange phase 842 of FIG. 8 are already completed. In example multi-AP operation 3100, a multi-AP selection phase 3130 is operated during period 3172, while a multi-AP data transmission phase 3150 is operated during period 3174 starting at time T1. In an example, period 3172 and period 3174 are separate apart to each other. As shown in FIG. 31, it is assumed that AP 3112 is unavailable for participating in multi-AP transmission during a period of unavailability 3160 starting at time T2. For example, the reason AP 3112 being unavailable during the period of unavailability 3160 may be that AP 3112 may schedule to receive a frame 3162 from STA 3116.

As shown in FIG. 31, example multi-AP operation 3100 may begin with multi-AP selection phase 3130 which is an example of multi-AP selection phase 1000 of FIG. 10. In an example, phase 3130 may include frame exchanges to allow master AP 3102 to determine whether candidate slave AP 3112 may participate in a multi-AP transmission. As shown in FIG. 31, AP 3102 designates slave AP 3112 for a multi-AP transmission.

As shown in FIG. 31, example multi-AP operation 3100 includes a phase 3140 after the completion of phase 3130. In an example, phase 3140 may include an optional frame 3142, a frame 3144, and a frame 3146.

In an embodiment, AP 3102 may transmit a frame 3142 to solicit frame 3144. In an example, frame 3142 may be a polling frame. In another embodiment, AP 3102 may not transmit a frame 3142 to solicit frame 3144.

In an embodiment, AP 3102 may receive a frame 3144 from AP 3112 at time T0. Frame 3144 may be an example of first frame 2544 of FIG. 25, In an embodiment, frame 3144 includes information indicating period of unavailability 3160 for AP 3112 to participate in the multi-AP transmission in phase 3150. In an embodiment, frame 3144 may be a management frame used as an action frame. In an example, information of period of unavailability 3160 included in frame 3144 may be included in an action field of the action frame corresponding to action field 2902 of FIG. 29.

In an embodiment, frame 3144 may be request frame requesting the AP 3102 to initiate the multi-AP transmission in phase 3150 outside of the period of unavailability 3160 of the AP 3112.

As discussed in example multi-AP operation 2500 of FIG. 25, AP 3102 may calculate a duration of a period 3170 between receiving frame 3144 at time T0 to the starting time T2 of period of unavailability 3160. In an embodiment, AP 3102 may compare the duration of period 3170 and a duration of a period 3174 used to perform the multi-AP transmission in phase 3150. As shown in FIG. 31, the duration of period 3170 is larger than the duration of period 3174. In an embodiment, AP 3102 schedules the AP 3112 to perform the multi-AP transmission in phase 3150 before period of unavailability 3160 based on receiving the information indicating period of unavailability 3160 included in frame 3144.

In an embodiment, to respond frame 3144, AP 3102 may transmit a frame 3146 indicating whether the request frame 3144 is accepted or rejected by the AP 3102. In an example, frame 3146 may indicate acceptance of the request from frame 3144 in an action detail field of the action frame corresponding to the action detail field 2910 of FIG. 29. In an example, the acceptance may be indicated in subfield 2920 for decision.

In an embodiment, AP 3102 transmits a frame 3152, which is an example of frame 2552 of FIG. 25, to AP 3112 to initiate the multi-AP transmission in phase 3150 during period 3174 based on the scheduling. As shown in FIG. 31, AP 3102 initiates phase 3150 starting at time T1 before the period of unavailability 3160.

As shown in FIG. 31, phase 3150 includes AP 3102 transmitting frame 3152 at time T1, AP 3102 transmitting a frame 3154 to STA 3104, AP 3112 transmitting a frame 3156 to STA 3114. In an example, frame 3154 and frame 3156 are data frames. In an example, the phase 3150 may further include BA frames transmitted from STA 3104 to AP 3102 and from STA 3114 to AP 3112, respectively.

In an example, phase 3150 is an example of phase 3050 of FIG. 30. As a result, AP 3112 successfully performs multi-AP transmission in phase 3150 with AP 3102 before the period of unavailability 3160 for AP 3112.

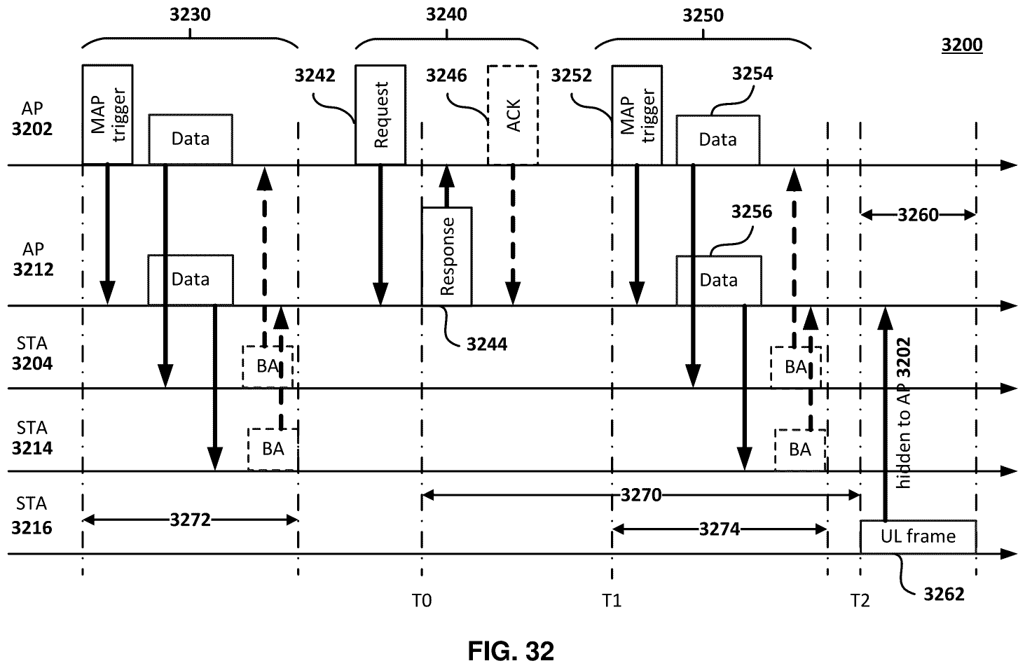

FIG. 32 illustrates an example multi-AP operation 3200 that may be used to carry out a multi-AP transmission according to an embodiment. Example multi-AP operation 3200 may include a first BSS and a second BSS. The first BSS may include an AP 3202 and a STA 3204. STA 3204 may be associated with AP 3202. The second BSS may include an AP 3212 and a plurality of STAs 3214 and 3216. STAs 3214 and 3216 may be associated with AP 3212. It is assumed that STA 3216 is hidden from AP 3202. In an example, AP 3202 and AP 3212 may form a multi-AP group. AP 3202 may be the master AP and AP 3212 may be a slave AP of the multi-AP group.

In an example, as shown in FIG. 32, it is assumed that multi-AP setup phase 840, and multi-AP information exchange phase 842, and multi-AP selection phase 846 of FIG. 8 are already completed. In example multi-AP operation 3200, a first multi-AP data transmission phase 3230 is operated during period 3272, while a second multi-AP data transmission phase 3250 is operated during period 3274 starting at time T1. In an example, period 3272 and period 3274 are separate apart to each other. As shown in FIG. 32, it is assumed that AP 3212 is unavailable for participating in multi-AP transmission during a period of unavailability 3260 starting at time T2. For example, the reason AP 3212 being unavailable during the period of unavailability 3260 may be that AP 3212 may schedule to receive a frame 3262 from STA 3216.

As shown in FIG. 32, example multi-AP operation 3200 may begin with the first multi-AP data transmission phase 3230 using procedures of multi-AP data transmission phase 1100 of FIG. 11. As shown in FIG. 32, example multi-AP operation 3200 includes a phase 3240 after the completion of phase 3230. In an example, phase 3240 may include a frame 3242, a frame 3244, and an optional frame 3246.

In an embodiment, AP 3202 may transmit a frame 3242 to request the AP 3212 to send a frame 3244 including information indicating a period of unavailability 3260 for AP 3212 to participate in the multi-AP transmission. In an embodiment, frame 3242 may be a management frame used as an action frame. For example, frame 3242 may be a request frame.

In an embodiment, AP 3202 may receive a frame 3244 from AP 3212 at time T0. Frame 3244 may be an example of first frame 2544 of FIG. 25, In an embodiment, frame 3244 includes information indicating period of unavailability 3260 for AP 3212 to participate in the multi-AP transmission in phase 3250. In an embodiment, frame 3244 may be a management frame used as an action frame. In an example, frame 3244 may be a response frame. In an example, information of period of unavailability 3260 included in frame 3244 may be included in an action field of the action frame corresponding to action field 2902 of FIG. 29.

As discussed in example multi-AP operation 2500 of FIG. 25, AP 3202 may calculate a duration of a period 3270 between receiving frame 3244 at time T0 to the starting time T2 of period of unavailability 3260. In an embodiment, AP 3202 may compare the duration of period 3270 and a duration of a period 3274 used to perform the multi-AP transmission in phase 3250. As shown in FIG. 32, the duration of period 3270 is larger than the duration of period 3274. In an embodiment, AP 3202 schedules the AP 3212 to perform the multi-AP transmission in phase 3250 before period of unavailability 3260 based on receiving the information indicating period of unavailability 3260 included in frame 3244.

In an embodiment, to respond frame 3244, AP 3202 may optionally transmit a frame 3246 to AP 3212 to confirm the receiving of frame 3244. For example, frame 3246 may be a Ack frame.

In an embodiment, AP 3202 transmits a frame 3252, which is an example of frame 2552 of FIG. 25, to AP 3212 to initiate the multi-AP transmission in phase 3250 during period 3274 based on the scheduling. As shown in FIG. 32, AP 3202 initiates phase 3250 starting at time T1 before the period of unavailability 3260.

As shown in FIG. 32, phase 3250 includes AP 3202 transmitting frame 3252 at time T1, AP 3202 transmitting a frame 3254 to STA 3204, AP 3212 transmitting a frame 3256 to STA 3214. In an example, frame 3254 and frame 3256 are data frames. In an example, the phase 3250 may further include BA frames transmitted from STA 3204 to AP 3202 and from STA 3214 to AP 3212, respectively.

In an example, phase 3250 is an example of phase 3150 of FIG. 31. As a result, AP 3212 successfully performs multi-AP transmission in phase 3250 with AP 3202 before the period of unavailability 3260 for AP 3212.

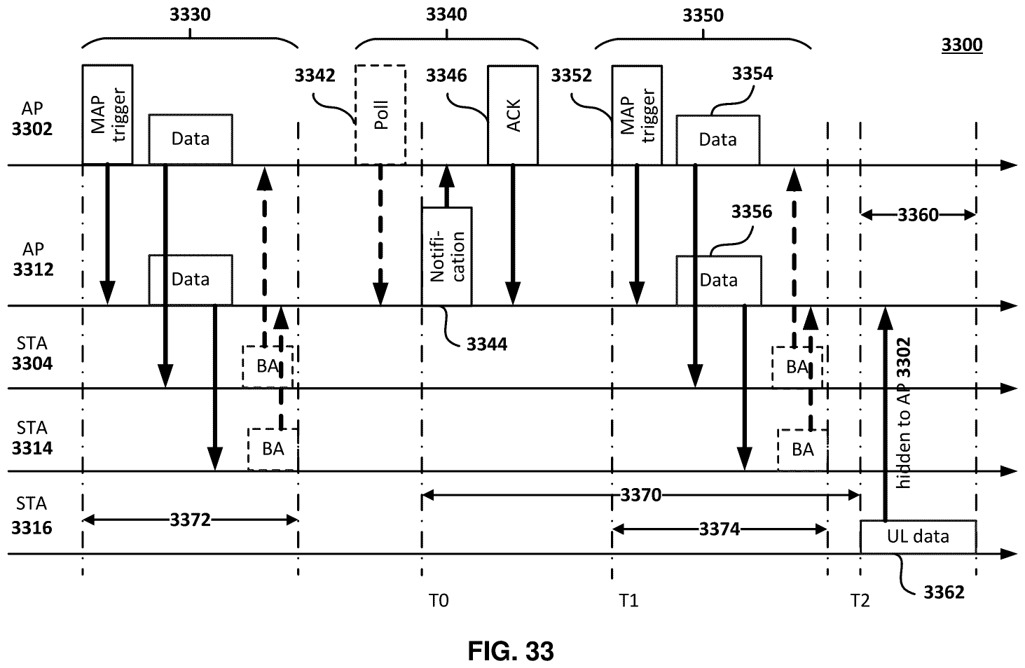

FIG. 33 illustrates an example multi-AP operation 3300 that may be used to carry out a multi-AP transmission according to an embodiment. Example multi-AP operation 3300 may include a first BSS and a second BSS. The first BSS may include an AP 3302 and a STA 3304. STA 3304 may be associated with AP 3302. The second BSS may include an AP 3312 and a plurality of STAs, STA 3314 and STA 3316. STAs 3314 and 3316 may be associated with AP 3312. It is assumed that STA 3316 is hidden from AP 3302. In an example, AP 3302 and AP 3312 may form a multi-AP group. AP 3302 may be the master AP and AP 3312 may be a slave AP of the multi-AP group.

In an example, as shown in FIG. 33, it is assumed that multi-AP setup phase 840, and multi-AP information exchange phase 842, and multi-AP selection phase 846 of FIG. 8 are already completed. In example multi-AP operation 3300, a first multi-AP data transmission phase 3330 is operated during period 3372, while a second multi-AP data transmission phase 3350 is operated during period 3374 starting at time T1. In an example, periods 3372 and 3374 are separate apart to each other. As shown in FIG. 33, it is assumed that AP 3312 is unavailable for participating in multi-AP transmission during a period of unavailability 3360 starting at time T2. For example, the reason AP 3312 being unavailable during the period of unavailability 3360 may be that AP 3312 may schedule to receive a frame 3362 from STA 3316.

Example multi-AP operation 3300 may begin with the first multi-AP data transmission phase 3330 using the procedures of multi-AP data transmission phase 1100 of FIG. 11. As shown in FIG. 33, example multi-AP operation 3300 includes a phase 3340 after the completion of phase 3330. In an example, phase 3340 may include an optional frame 3342, a frame 3344, and a frame 3346.

In an embodiment, AP 3302 may transmit a frame 3342 to solicit frame 3344. In an example, frame 3342 may be a polling frame. In another embodiment, AP 3302 may not transmit frame 3342 to solicit frame 3344.

In an embodiment, AP 3302 may receive a frame 3344 from AP 3312 at time T0. Frame 3344 may be an example of first frame 2544 of FIG. 25, In an embodiment, frame 3344 includes information indicating period of unavailability 3360 for AP 3312 to participate in the multi-AP transmission in phase 3350. In an embodiment, frame 3344 may be a management frame used as an action frame. In an example, information of period of unavailability 3360 included in frame 3344 may be included in an action field of the action frame corresponding to action field 2902 of FIG. 29. For example, frame 3344 may be a notification frame.

As discussed in example multi-AP operation 2500 of FIG. 25, AP 3302 may calculate a duration of a period 3370 between receiving frame 3344 at time T0 to the starting time T2 of period of unavailability 3360. In an embodiment, AP 3302 may compare the duration of period 3370 and a duration of a period 3374 used to perform the multi-AP transmission in phase 3350. As shown in FIG. 32, the duration of period 3370 is larger than the duration of period 3374. In an embodiment, AP 3302 schedules the AP 3312 to perform the multi-AP transmission in phase 3350 before period of unavailability 3360 based on receiving the information indicating period of unavailability 3360 included in frame 3344.

In an embodiment, to respond frame 3344, AP 3302 may transmit a frame 3346 to AP 3312 to confirm the receiving of frame 3244. For example, frame 3346 may be an Ack frame.

In an embodiment, AP 3302 transmits a frame 3352, which is an example of frame 2552 of FIG. 25, to AP 3312 to initiate the multi-AP transmission in phase 3350 during period 3374 based on the scheduling. As shown in FIG. 33, AP 3302 initiates phase 3350 starting at time T1 before the period of unavailability 3360.

As shown in FIG. 33, phase 3350 includes AP 3302 transmitting frame 3352 at time T1, AP 3302 transmitting a frame 3354 to STA 3304, AP 3312 transmitting a frame 3356 to STA 3314. In an example, frame 3354 and frame 3356 are data frames. In an example, the phase 3350 may further include BA frames transmitted from STA 3304 to AP 3302 and from STA 3314 to AP 3312, respectively.

In an example, phase 3350 is an example of phase 3150 of FIG. 31. As a result, AP 3312 successfully performs multi-AP transmission in phase 3350 with AP 3302 before the period of unavailability 3360 for AP 3312.

As would be understood by a person of skill in the art based on the teachings herein, the examples disclosed in relation to FIG. 25, FIG. 26, FIG. 27, FIG. 30, FIG. 31, FIG. 32, and FIG. 33 may be readily extended to cases including more than two APs.

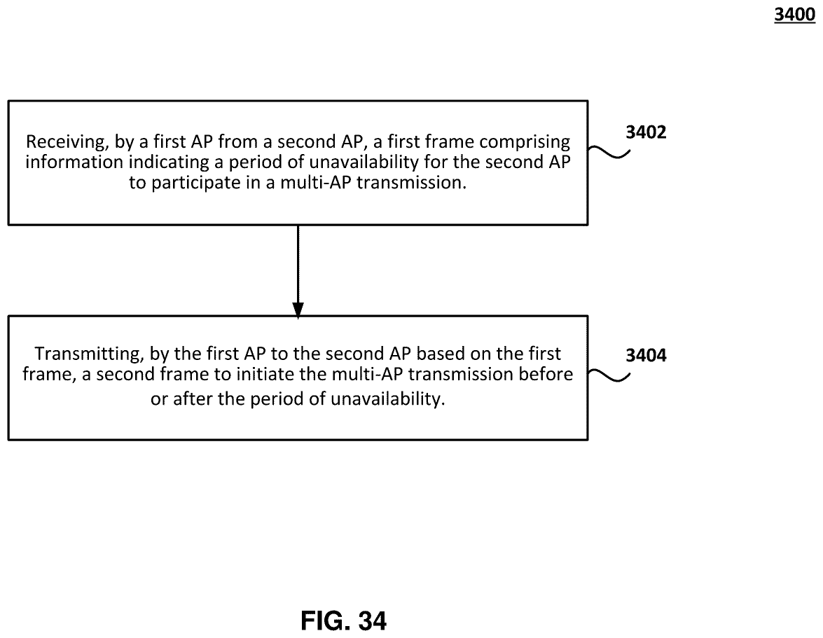

FIG. 34 illustrates an example process 3400 according to an embodiment. Example process 3400 is provided for the purpose of illustration only and is not limiting of embodiments. Process 3400 may be performed by a first AP. The first AP may be a master AP of a multi-AP group.

As shown in FIG. 34, process 3400 begins in step 3402, which includes receiving, by a first AP from a second AP, a first frame comprising information indicating a period of unavailability for the second AP to participate in a multi-AP transmission.

In an embodiment, the first AP schedules the second AP to perform the multi-AP transmission before or after the period of unavailability based on the first frame. In an embodiment, the first AP and the second AP belong to different BSSs. In an embodiment, the information further indicates a starting time and a duration of the period of unavailability. In an embodiment, the period of unavailability comprises a plurality of periods of unavailability. In an embodiment, the information further indicates a periodicity for the plurality of periods of unavailability. In an embodiment, the information further indicates one or more offsets between the plurality of periods of unavailability comprising the period of unavailability.

In an embodiment, the first frame comprises a data frame. In an embodiment, the data frame comprises a feedback frame to a trigger frame. In an embodiment, data frame comprises a high throughput (HT) control field comprising the information indicating the period of unavailability.

In an embodiment, the first frame comprises a management frame. In an embodiment, management frame comprises an action frame comprising an action field comprising the information indicating the period of unavailability. In an embodiment, the action frame comprises a request frame requesting the first AP to initiate the multi-AP transmission outside of the period of unavailability of the second AP. In an embodiment, the method further comprises transmitting a response frame in response to the request frame. In an embodiment, the response frame indicates whether the request frame is accepted or rejected by the first AP. In an embodiment, the first AP transmits, to the second AP, a polling frame to solicit the first frame. In an embodiment, the first AP transmitting a request frame requesting the second AP to send the first frame, wherein the action frame comprises a response frame in response to the request frame. In an embodiment, the action frame comprises a notification frame indicating to the first AP the period of unavailability of the second AP. In an embodiment, the first AP transmits, to the second AP, a polling frame to solicit the first frame. In an embodiment, the first AP transmits an acknowledgment to acknowledge reception of the first frame.

As shown in FIG. 34, in step 3404, process 3400 includes transmitting, by the first AP to the second AP based on the first frame, a second frame to initiate the multi-AP transmission before or after the period of unavailability.

In an embodiment, the second frame comprises a control frame or a management frame.

In an embodiment, process 3400 may further comprise: receiving, by the first AP from the second AP, a first indication of support by the second AP of a period coordination capability; and transmitting, by the first AP to the second AP, a second indication of support by the first AP of the period coordination capability. In an embodiment, the period coordination capability allows the first AP to receive the first frame. In an embodiment, the period coordination capability allows the first AP to transmit the second frame. In an embodiment, the period coordination capability allows the second AP to transmit the first frame. In an embodiment, the period coordination capability allows the second AP to receive the second frame.

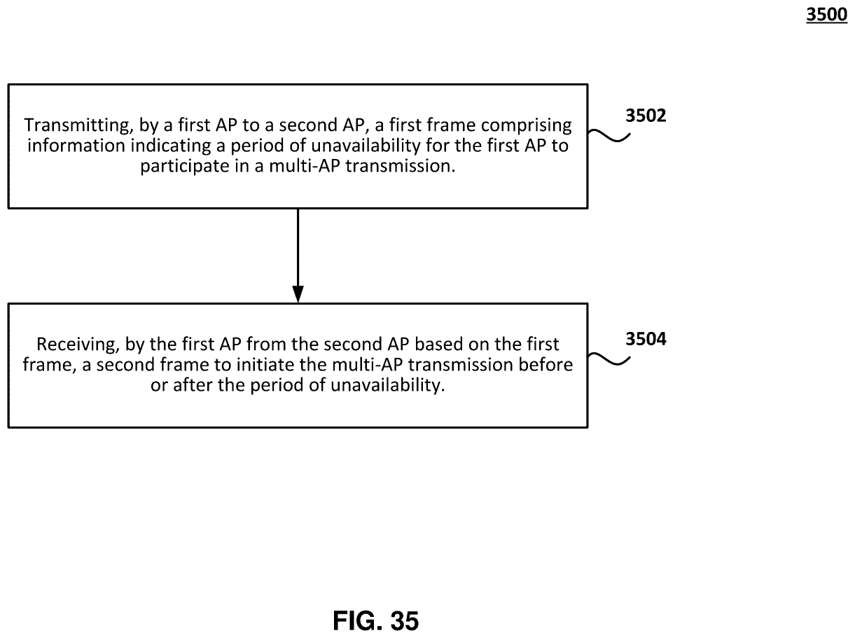

FIG. 35 illustrates an example process 3500 according to an embodiment. Example process 3500 is provided for the purpose of illustration only and is not limiting of embodiments. Process 3500 may be performed by a first AP. The first AP may be a slave AP of a multi-AP group.

As shown in FIG. 35, process 3500 begins in step 3502, which includes transmitting, by a first AP to a second AP, a first frame comprising information indicating a period of unavailability for the first AP to participate in a multi-AP transmission.

In an embodiment, the first AP and the second AP belong to different BSSs. In an embodiment, the information further indicates a starting time and a duration of the period of unavailability. In an embodiment, the period of unavailability comprises a plurality of periods of unavailability. In an embodiment, the information further indicates a periodicity for the plurality of periods of unavailability. In an embodiment, the information further indicates one or more offsets between the plurality of periods of unavailability comprising the period of unavailability.

In an embodiment, the first frame comprises a data frame. In an embodiment, the data frame comprises a feedback frame to a trigger frame. In an embodiment, data frame comprises a high throughput (HT) control field comprising the information indicating the period of unavailability.

In an embodiment, the first frame comprises a management frame. In an embodiment, management frame comprises an action frame comprising an action field comprising the information indicating the period of unavailability. In an embodiment, the action frame comprises a request frame requesting the second AP to initiate the multi-AP transmission outside of the period of unavailability of the first AP. In an embodiment, the method further comprises transmitting a response frame in response to the request frame. In an embodiment, the response frame indicates whether the request frame is accepted or rejected by the second AP. In an embodiment, the method further comprises transmitting, to the second AP, a polling frame to solicit the first frame. In an embodiment, the method further comprises receiving a request frame requesting the second AP to send the first frame, wherein the action frame comprises a response frame in response to the request frame. In an embodiment, the action frame comprises a notification frame indicating to the first AP the period of unavailability of the first AP. In an embodiment, the method further receiving, by the first AP, a polling frame to solicit the first frame. In an embodiment, the method further transmitting an acknowledgment to acknowledge reception of the first frame.

As shown in FIG. 35, in step 3504, process 3500 includes receiving, by the first AP from the second AP based on the first frame, a second frame to initiate the multi-AP transmission before or after the period of unavailability.

In an embodiment, the second frame comprises a control frame or a management frame.

In an embodiment, process 3500 may further comprise: transmitting, by the first AP to the second AP, a first indication of support by the first AP of a period coordination capability; and receiving, by the first AP from the second AP, a second indication of support by the second AP of the period coordination capability. In an embodiment, the period coordination capability allows the first AP to transmit the first frame. In an embodiment, the period coordination capability allows the first AP to receive the second frame. In an embodiment, the period coordination capability allows the second AP to receive the first frame. In an embodiment, the period coordination capability allows the second AP to transmit the second frame.

What is claimed is:

1. A first access point (AP) comprising:
one or more processors; and
memory storing instructions that, when executed by the one or more processors, cause the first AP to:
receive, by the first AP from a second AP, a first frame comprising information indicating a period for a multi-AP transmission;
transmit, by the first AP to the second AP, a second frame indicating a decision by the first AP to participate in the multi-AP transmission based on the first frame; and
receive, by the first AP from the second AP, a third frame to initiate the multi-AP transmission based on the decision.

2. The first AP of claim 1, wherein the information further indicates a starting time and a duration of the period for the multi-AP transmission.

3. The first AP of claim 1, wherein the period for the multi-AP transmission comprises a plurality of periods for multi-AP transmissions.

4. The first AP of claim 1, wherein the first frame comprises a control frame, and wherein the control frame comprises a trigger frame for soliciting the first AP to participate in the multi-AP transmission within the period for the multi-AP transmission.

5. The first AP of claim 4, wherein the trigger frame comprises at least one of: (i) a field in a user info list comprising the information indicating the period for the multi-AP transmission or (ii) a common info field comprising the information indicating the period for the multi-AP transmission.

6. The first AP of claim 1, wherein the first frame comprises a management frame.

7. The first AP of claim 6, wherein the management frame comprises an action frame comprising a request frame requesting the first AP to participate in the multi-AP transmission within the period for the multi-AP transmission, and wherein the action frame further comprises an action field comprising the information indicating the period for the multi-AP transmission.

8. A first access point (AP) comprising:
one or more processors; and
memory storing instructions that, when executed by the one or more processors, cause the first AP to:
receive, by the first AP from a second AP, a first frame comprising information indicating a period of unavailability for the second AP to participate in a multi-AP transmission; and
transmit, by the first AP to the second AP based on the first frame, a second frame to initiate the multi-AP transmission before or after the period of unavailability.

9. The first AP of claim 8, wherein the information further indicates a starting time and a duration of the period of unavailability.

10. The first AP of claim 8, wherein the instructions, when executed by the one or more processors, further cause the first AP to schedule the second AP to perform the multi-AP transmission before or after the period of unavailability based on the first frame.

11. The first AP of claim 8, wherein the period of unavailability comprises a plurality of periods of unavailability.

12. The first AP of claim 8, wherein the first frame comprises a data frame, the data frame comprising feedback to a trigger frame and comprising a high throughput (HT) control field comprising the information indicating the period of unavailability.

13. The first AP of claim 8, wherein the first frame comprises a management frame, the management frame comprising an action frame comprising an action field comprising the information indicating the period of unavailability.

14. The first AP of claim 13, wherein:
the action frame comprises a request frame requesting the first AP to initiate the multi-AP transmission outside of the period of unavailability of the second AP;
the instructions, when executed by the one or more processors, further cause the first AP to transmit a response frame in response to the request frame; and
the response frame indicates whether the request frame is accepted or rejected by the first AP.

15. A non-transitory computer-readable medium comprising instructions that, when executed by one or more processors of a first access point (AP), cause the first AP to:
receive, by the first AP from a second AP, a first frame comprising information indicating a period for a multi-AP transmission;
transmit, by the first AP to the second AP, a second frame indicating a decision by the first AP to participate in the multi-AP transmission based on the first frame; and
receive, by the first AP from the second AP, a third frame to initiate the multi-AP transmission based on the decision.

16. The non-transitory computer-readable medium of claim 15, wherein the information further indicates a starting time and a duration of the period for the multi-AP transmission.

17. The non-transitory computer-readable medium of claim 15, wherein the period for the multi-AP transmission comprises a plurality of periods for multi-AP transmissions.

18. The non-transitory computer-readable medium of claim 15, wherein the first frame comprises a control frame, and wherein the control frame comprises a trigger frame for soliciting the first AP to participate in the multi-AP transmission within the period for the multi-AP transmission.

19. The non-transitory computer-readable medium of claim 18, wherein the trigger frame comprises at least one of: (i) a field in a user info list comprising the information indicating the period for the multi-AP transmission or (ii) a common info field comprising the information indicating the period for the multi-AP transmission.

20. The non-transitory computer-readable medium of claim 15, wherein the first frame comprises a management frame, wherein the management frame comprises an action frame comprising a request frame requesting the first AP to participate in the multi-AP transmission within the period for the multi-AP transmission, and wherein the action frame further comprises an action field comprising the information indicating the period for the multi-AP transmission.
